(19) United States
(12) Patent Application Publication
(10) Pub. No.: US 2007/0174618 A1
(43) Pub. Date: Jul. 26, 2007

(54) Information security apparatus and information security system

(76) Inventors: Toshihisa Nakano, Osaka (JP); Motoji Ohmori, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/591,276

(22) PCT Filed: Mar. 11, 2005
(86) PCT No.: PCT/JP05/04852

§ 371 Date: Aug. 31, 2006

(30) Foreign Application Priority Data
Mar. 16, 2004 (JP) 2004-074739

(51) Int. Cl. H04L 9/00

(52) U.S. Cl. 713/171

(57) ABSTRACT

An information security apparatus that manages information in a safe and reliable manner based on a complexity of an inverse operation on a set of integers that satisfy a condition. The information security apparatus comprises a private key generating unit operable to generate a private key, a parameter receiving unit operable to receive parameters which respectively determine conditions, and a public key generating unit operable to generate, with use of the private key, public keys from sets of integers that satisfy the conditions determined by the parameters.

### TECHNICAL FIELD

The present invention relates to a technique for realizing safe and secure transmission and reception of contents.

### BACKGROUND ART

When a terminal device uses services provided by a contents provider, the terminal device and a server belonging to the contents provider perform two-way authentication. If the two-way authentication succeeds, the terminal device and the server share a private key, and thereby establish a so-called SAC (Secure Authentication Channel), which is a secure data transmission channel. The terminal device and the server transmit and receive contents to and from each other via the SAC. Such a technique is disclosed by Patent Document 1.

In recent years, the number of contents service providers has been increasing. Therefore, there are demands for a system that supports the case where one terminal device uses services provided by a plurality of contents providers.

Patent Document 1

Japanese Laid-open Patent Document No. 11-234259.

### DISCLOSURE OF THE INVENTION

The present invention therefore aims to provide an information security apparatus and an information security system that are suitable for the case where one terminal device uses services provided by a plurality of contents providers.

The object can be achieved by an information security apparatus that manages information in a safe and reliable manner based on a complexity of an inverse operation on a set of integers that satisfy a condition, the information security apparatus comprising: a private key generating unit operable to generate a private key; a parameter receiving unit operable to receive parameters which respectively determine conditions; and a public key generating unit operable to generate, with use of the private key, public keys from sets of integers that satisfy the conditions determined by the parameters.

With the stated structure, the information security apparatus generates the plurality of the public keys from the private key. Therefore, in the case of generating the plurality of the public keys, the structure has an advantage that the number of the keys that should be generated and managed becomes fewer than that of the conventional device in which the private key and the public key correspond to each other on a one-to-one basis.

Here, the information security apparatus may be connected to servers via a network, the parameters may be received from the servers respectively and be different from each other, and the public key generating unit may generate public keys which are different from each other, with use of the respective parameters.

With the stated structure, the information security apparatus can generate the different public keys from the one private key by receiving the different parameters from the respective servers. Therefore, the structure has an advantage that the number of the keys that should be generated and managed becomes fewer than that of the conventional device, which generates a pair of the private key and the public key for each server with which the device communicates.

Here, the information security apparatus may further comprise: a public key transmission unit operable to transmit the public keys to respective source servers that are sources of the respective parameters; a public key certification receiving unit operable to receive public key certifications from the respective servers, each public key certification including each public key and a signature of each server; and a key storage unit operable to store the private key and the public key certifications.

With the stated structure, the number of the keys that the key storage unit of the information security apparatus stores becomes fewer than the that of the conventional device, which stores a pair of the private key and the public key for each server with which the device communicates. This means that the capacity of the storage area can be reduced, and therefore the cost can be reduced.

Here, the information security apparatus may further comprise: a contents request unit operable to read out one of the public key certifications from the key storage unit, and transmit a contents request that includes the read-out public key certification to a source server that has issued the read-out public key certification; and a contents acquiring unit operable to acquire contents from the source server in a safe and reliable manner with use of the private key and the public key included in the read-out public key certification.

With the stated structure, the information security apparatus can receive contents from the corresponding server in the secure manner, by selecting one public key certification from the stored plurality of the public key certifications, and using the one private key and the public key that is included in the selected public key certification.

Here, the contents acquiring unit may include: an authenticating unit operable to transmit, to the source server, signature data that is generated with use of the private key and to be authenticated by the source server with use of the public key, and authenticate the source server; a key sharing unit operable to share key information with the source server if the authentication performed by the authentication unit succeeds; a receiving unit operable to receive encrypted contents, which are encrypted based on the key information, from the source server; and a decrypting unit operable to decrypts the encrypted contents based on the key information.

With the stated structure, the information security apparatus can establish a secure data transmission channel with the server, by performing two-way authentication with the server and sharing the key information in the secure manner after the authentication.

Here, the key storage unit may be a portable memory card that is inserted in the information security apparatus, the public key generating unit may write the private key and the public key certifications into the potable memory card, and the portable memory card may include a secure storage area that is secure against tampering and cryptanalysis from outside, and stores the private key in the secure storage area.

With the stated structure, the storage device included in the information security apparatus is realized by the portable memory card. The information security apparatus can hold the private key in the secure manner by storing the private key in the tamper-resistant module included in the memory card.

Here, the information security apparatus may further comprise: a memory card authenticating unit operable to authenticate the memory card when the memory card is inserted into the information security apparatus; and a write-inhibit unit operable to inhibit the public key generating unit from writing the private key and the public key certifications into the memory card if the authentication performed by the memory card authenticating unit fails.

With the stated structure, the information security apparatus writes the private key and the public key certifications in the memory card only when the authentication of the memory card succeeds. Therefore, the structure prevents the private key from being written into an unauthorized memory card and exposed.

Here, security of the information security apparatus may be based on an elliptic curve discrete logarithm problem, the parameter receiving unit may receive parameters that constitute an elliptic curve, and the public key generating unit may generate the public keys by performing, for each parameter, a multiplication with use of the elliptic curve on the private key.

With the stated structure, the information security apparatus can acquire contents in the safe and secure manner by using the elliptic curve cryptosystem that provides high security.

Here, security of the information security apparatus may be based on an RSA cryptosystem, the private key generating unit may generate a private key d, the parameter receiving unit may receive sets of prime numbers (P, Q) as the parameters, and the public key generating unit may generate sets of the public keys (N, e) by calculating N=PQ and further calculating e from ed≡1 mod(P−1) (Q−1), for each set of the prime numbers.

With the stated structure, the information security apparatus uses the RSA cryptosystem as the public key cryptosystem, and therefore the present invention can be realized with a general-purpose computer system.

### BRIEF DESCRIPTION OF THE DRAWINGS

FIG. 1 shows a structure of an information security system 1;

FIG. 2 is a functional block diagram showing a structure of a terminal device 10;

FIG. 3A shows a data structure of a password table 120;

FIG. 3B shows a data structure of a CRL 130;

FIG. 4 is a functional block diagram showing a structure of a memory card 20;

FIG. 5 is a functional block diagram showing a structure of a server 30;

FIG. 6 is a flowchart showing overall operations performed by an information security system 1, the flowchart continuing to FIG. 15;

FIG. 7 is a flowchart showing operations performed by a terminal device 10 for authenticating a memory card 20;

FIG. 8 is a flowchart showing operations performed by Certification Authority (CA) and each device (a terminal device, a server 30, a server 40 and a server 50) for issuing a public key certification;

FIG. 9A shows a data structure of a public key certification 140 (Cert_0010);

FIG. 9B shows a data structure of a public key certification 150 (Cert_0030);

FIG. 9C shows a data structure of a public key certification 160 (Cert_0040);

FIG. 9D shows a data structure of a public key certification 170 (Cert_0050);

FIG. 10 is a flowchart showing operations performed by a terminal device 10 and servers at the time of service subscription and registration, the flowchart continuing to a flowchart in FIG. 11;

FIG. 11 is a flowchart showing operations performed by a terminal device 10 and servers at the time of service subscription and registration, the flowchart being continued from FIG. 10;

FIG. 12A shows a data structure of a public key certification 210 (Cert_A) that is issued by a server 30 to a terminal device 10;

FIG. 12B shows a data structure of a public key certification 220 (Cert_B) that is issued by a server 40 to a terminal device 10;

FIG. 12C shows a data structure of a public key certification 230 (Cert_C) that is issued by a server 50 to a terminal device 10;

FIG. 13 is a flowchart showing operations for SAC establishment processing performed by a terminal device 10 and servers at the time of service subscription and registration, the flowchart continuing to FIG. 14;

FIG. 14 is a flowchart showing operations for SAC establishment processing performed by a terminal device 10 and servers at the time of service subscription and registration, the flowchart being continued from FIG. 13;

FIG. 15 is a flowchart showing overall operations performed by an information security system 1, the flowchart being continued from FIG. 6;

FIG. 16 is a flowchart showing operations for SAC establishment processing performed by a terminal device 10 and servers at the time of service usage, the flowchart being continued from FIG. 17;

FIG. 17 is a flowchart showing operations for SAC establishment processing performed by a terminal device 10 and servers at the time of service usage, the flowchart being continued from FIG. 16 and continuing to FIG. 18;

FIG. 18 is a flowchart showing operations for SAC establishment processing performed by a terminal device 10 and servers at the time of service usage, the flowchart being continued from FIG. 17; and

FIG. 19 is a flowchart showing operations performed by Certification Authority for generating system parameters for an elliptic curve.

### BEST MODE FOR CARRYING OUT THE INVENTION

An information security system 1 as an embodiment of the present invention is described here. The information security system 1 is a system in which one terminal device uses services provided by a plurality of contents providers.

The following describe the information security system 1, with reference to drawings.

Structure

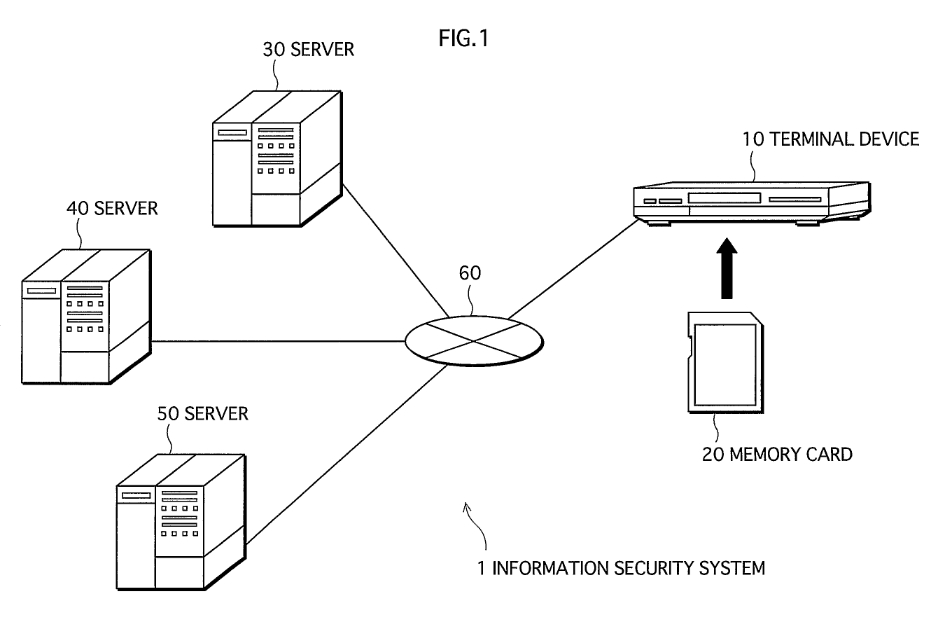

FIG. 1 shows a structure of an information security system 1. As shown in FIG. 1, the information security system 1 includes a terminal device 10, a memory card 20, a server 30, a server 40 and a server 50. The memory card 20 is to be used after inserted into a memory card slot of the terminal device 10. The terminal device 10 and the servers 30, 40 and 50 are connected to each other via a network 60. The network 60 is, for instance, the Internet.

The terminal device 10 and the memory card 20 belong to a user who uses contents distribution services, and each of servers 30, 40 and 50 belongs to a different contents provider. The content providers provide the user with the contents distribution services.

The terminal device 10, the memory card 20, and the servers 30, 40 and 50 deal with contents in a safe and secure manner. Therefore, these devices are sometimes generically called an information security apparatus.

1. Terminal Device 10

The structure of the terminal device 10 is described next in detail.

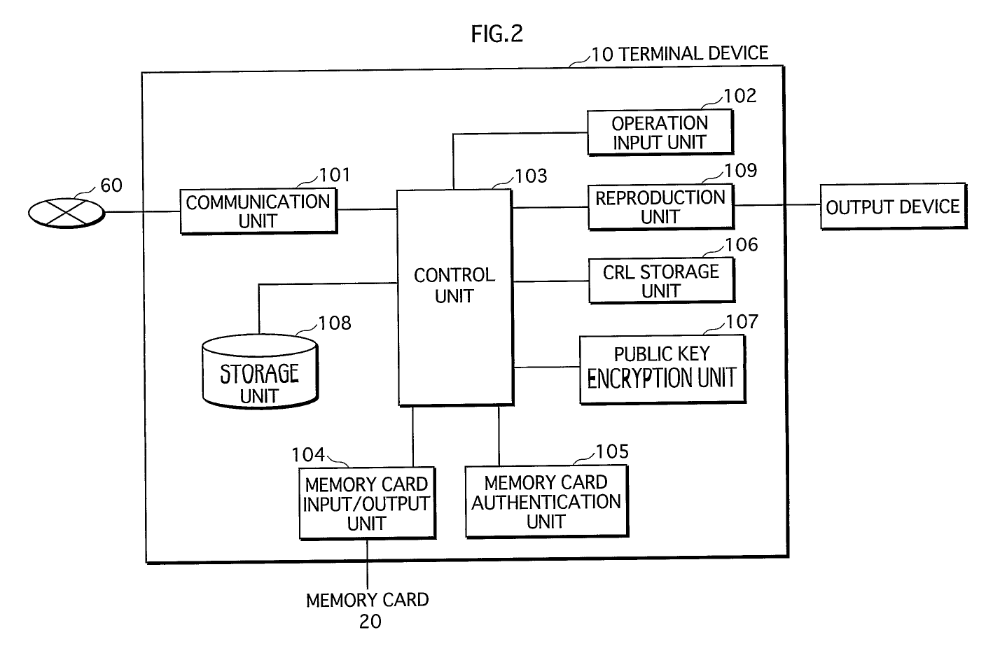

FIG. 2 is a functional block diagram that shows the structure of the terminal device 10 functionally. As shown in FIG. 2, the terminal device 10 includes a communication unit 101, an operation input unit 102, a control unit 103, a memory card input/output unit 104, a memory card authentication unit 105, a CRL storage unit 106, a public key encryption unit 107, a storage unit 108 and a reproduction unit 109.

The terminal device 10 is, more specifically, a computer system that includes a microprocessor, a ROM, a RAM, a hard disk, a drive unit, a network connection unit, an MPEG decoder, an MPEG encoder, a memory card slot, and so on.

(1) Communication Unit 101

The communication unit 101 is a network connection unit including a web browser. The communication unit 101 is connected to the servers 30, 40 and 50 via the network 60.

The communication unit 101 receives information from the server 30 via the network 60, and outputs the received information to the control unit 103. The communication unit 101 also receives information from the control unit 103, and outputs the received information to the server 30 via the network 60. In the same way, the communication unit 101 receives information from the server 40 via the network 60, and outputs the received information to the control unit 103. The communication unit 101 also receives information from the control unit 103, and outputs the received information to the server 40 via the network 60. In the same way, the communication unit 101 receives information from the server 50 via the network 60, and outputs the received information to the control unit 103. The communication unit 101 also receives information from the control unit 103, and outputs the received information to the server 50 via the network 60.

Here, the information that the communication unit 101 transmits to each server is, more specifically, a service subscription request, a service usage request, signature data used for establishing SAC between the terminal device 10 and each server, key information, and so on. The information that the communication unit 101 receives from each server is, more specifically, signature data used for establishing SAC with each server, key information, system parameters for an elliptic curve, contents transmitted from each server after authentication and key sharing are performed, and so on.

Further, the communication unit 101 is connected to a Certification Authority (hereinafter called the “CA”) via the network 60. The communication unit 101 transmits and receives information to and from the CA in the following manner.

The communication unit 101 keeps CRL (Certification Revocation List), which is received from the CA, up to date all the time, and stores the received up-to-date CRL in the CRL storage unit 106 via the control unit 103. The CRL is described later.

The communication unit 101 receives a public key “PK_0010” from the public key encryption unit 107 via the control unit 103, and transmits the received public key to the CA. The communication unit 101 also receives a public key certification “Cert_0010” that corresponds to the public key “PK_0010” from the CA, and outputs the received public key certification to the control unit 103.

In this Description, “the system parameters for the elliptic curve” are “a” and “b” that are included in the elliptic curve E: y²=x³+ax²+b, a prime number “p”, an order of the prime number p “q”, and an arbitrary point (base point) “G” on the elliptic curve E.

(2) Operation Input Unit 102

The operation input unit 102 includes, for instance, buttons used for receiving operations from the user. Upon receiving an operation from the user, the operation input unit 102 generates an operation signal corresponding to the received operation, and outputs the generated operation signal to the control unit 103.

Here, the operation signal is, more specifically, a signal representing the service subscription request, a signal representing the service usage request, and so on.

(3) Control Unit 103

The control unit 103 includes a microprocessor, a ROM, a RAM and so on. The control unit 103 controls the entire terminal device 10 by performing the following processing with use of the microprocessor that executes a computer program.

(a) Receiving a signal indicating that an insertion of the memory card 20 is detected from the memory card input/output unit 104, the control unit 103 outputs an instruction to the memory card authentication unit 105 to perform authentication of the memory card 20.

(b) Upon receiving a signal representing “authentication OK/” from the memory card authentication unit 105, the control unit 103 receives the public key certification from the CA. More specifically, the control unit 103 transmits a public key “PK_0011” that is output by the public key encryption unit 107, and a device ID “ID_0010” of the control unit 103 itself prestored in the control unit 103, to the CA via the communication unit 101. The control unit 103 receives a public key certification “Cert_0010,” corresponding to the public key “PK_0010” from the CA via the communication unit 101, and outputs the received public key certification to the memory card 20 via the memory card input/output unit 104.

(c) The control unit 103 receives an operation signal from the operation input unit 102, and performs processing according to the received operation signal.

For instance, upon receiving, from the operation input unit 102, an operation signal indicating the service subscription request for subscribing the services provided by the server 30, the server 40 or the server 50, the control unit 103 outputs an instruction to the memory card input/output unit 104 to read out the public key certification “Cert_0010” from the memory card 20, outputs an instruction to the public key encryption unit 107 to establish the SAC, and outputs an instruction to the public key encryption unit 107 to perform the service subscription.

Upon receiving, from the operation input unit 102, a signal indicating the service usage request for using the services provided by the server 30, the server 40 or the server 50, the control unit 103 outputs an instruction to the memory card input/output unit 104 to read out a private key for service SK and the public key certification received from the server corresponding to the request from the memory card 20. Further, the control unit 103 outputs an instruction to the public key encryption unit 107 to establish the SAC, and outputs the instruction to the public key encryption unit 107 to acquire contents.

(d) After establishing the SAC between the terminal device 10 and the server 30, the server 40 or the server 50, the control unit 103 receives a session key from the public key encryption unit 107 at the time of the transmission or the reception of information between the terminal device 10 and each server. The received session key is used as an encryption key or a decryption key for encrypting information that is to be transmitted to the server or decrypting encrypted information that is received from the server.

(4) Memory Card Input/Output Unit 104

The memory card input/output unit 104 includes the memory card slot. Upon detecting that the memory card 20 is inserted into the memory card slot, the memory card input/output unit outputs a signal representing the detection to the control unit 103. The memory card input/output unit 104 also performs input and output of information between the control unit 103 and the memory card 20, in the state where the memory card 20 is inserted into the memory card slot.

(5) Memory Card Authentication Unit 105

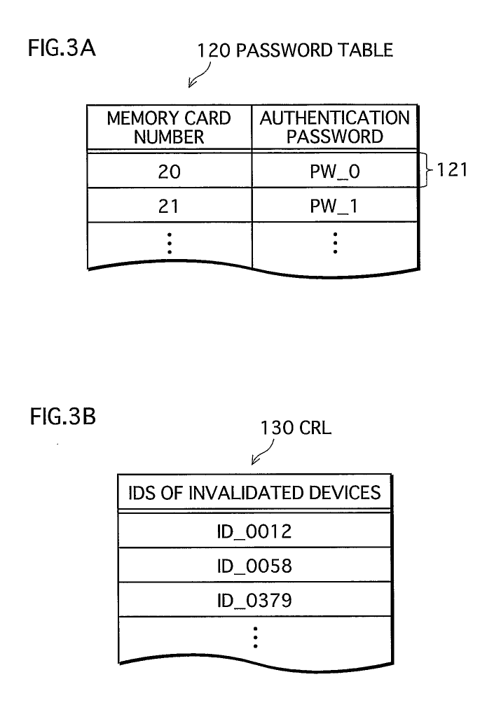

The memory card authentication unit 105 includes a microprocessor, a ROM, a RAM and soon. The ROM or the RAM stores a password table 120 that is shown in FIG. 3A.

The password table 120 includes one or more password information sets. Each password information set includes a memory card number and an authentication password. The memory card number is used for identifying a memory card that is available in the state where it is inserted in the terminal device 10. The authentication password is shared between the terminal device 10 and the memory card that is identifiable with the memory card number corresponding to the authentication password. The authentication password is 256-bit data that is used for authenticating the memory card.

Receiving the signal indicating that the memory card 20 is inserted into the memory card input/output unit 104 from the control unit 103, the memory card authentication unit 105 reads out a password information set 121 corresponding to the memory card 20 from the password table 120, and further reads out an authentication password PW_0 from the password information set 121. The memory card authentication unit 105 also generates a 56-bit random number R_0. The memory card authentication unit 105 outputs the generated random number R_0 to the memory card 20 via the control unit 103 and the memory card input/output unit 104. At the same time, the memory card authentication unit 105 applies an encryption algorithm E to the authentication password PW_0 to generate an encrypted text E1, with use of the random number R_0 as an encryption key. Then, the memory card authentication unit 105 stores the generated encrypted text E1. Here, the encryption algorithm E is DES (Data Encryption Standard) for instance.

Receiving an encrypted text E2 from the memory card 20 via the control unit 103 and the memory card input/output unit 104, the memory card authentication unit 105 compares the received encrypted text E2 with the stored encrypted text E1. If the E1 is identical with the E2, the memory card authentication unit 105 outputs a signal representing “authentication OK” to the control unit 103, and if the E1 is different from the E2, the memory card authentication unit 105 outputs a signal representing “authentication NG” to the control unit 103.

(6) CRL Storage Unit 106

The CRL storage unit 106 includes a RAM, and stores therein a CRL. The CRL is a list of invalidated devices, such as a device that has performed unauthorized operations and a device whose private key has been exposed.

The CRL is managed by the CA. The terminal device 10 receives the CRL from the CA via the network 60, and stores the CRL in the CRL storage unit 106. Here, the terminal device 10 keeps the CRL received from the CA up to date all the time. The terminal device 10 replaces the old CLR already stored in the CRL storage unit 106 with the up-to-date CRL.

The details of the CRL are disclosed in: American National Standards Institute, American National Standard for Financial Services, ANSX9.57: Public Key Cryptography for the Financial Industry: Certificate Management, 1997.

(7) Public Key Encryption Unit 107

The public key encryption unit 107 includes a microprocessor, a ROM, a RAM, a random number generator, and so on.

At the time of transmitting the service subscription request to the servers 30, 40 and 50, the public key encryption unit 107 performs processing for establishing the SAC with each server. Also, at the time of transmitting the service usage request to the servers 30, 40 and 50, the public key encryption unit 107 performs processing for establishing the SAC with each server. The public key cryptosystem used here is the elliptic curve cryptosystem and the RSA cryptosystem.

Elliptic Curve Discrete Logarithm Problem

The elliptic curve discrete logarithm problem, which is used as a basis for security of the elliptic curve cryptosystem, is described next.

Assume that E(GF(p)) is an elliptic curve defined over a finite field GF(p), with a base point G on the elliptic curve E being set as a base point when the order of the elliptic curve E is exactly divided by a large prime. In this case, the discrete logarithm problem is to compute an integer x, if any, that satisfies the equation;
Y=x*G, where Y is a given element on the elliptic curve E.

Here, p is a prime and GF(p) is a finite field that includes p elements. In this Description, the symbol “*” represents repeated additions of an element included in the elliptic curve, and “x*G” means to add the base point G included in the elliptic curve x times, in the manner shown by the next equation;
x*G=G+G+G+ . . . +G.

The security of the public key cryptosystem is based on the discrete logarithm problem, because the discrete logarithm problem for the finite field GF(p) including a large number of elements is extremely difficult.

The details of the discrete logarithm problem are disclosed in: Neal Koblitz, “A Course in Number Theory and Cryptography”, Springer-Verlag, 1987.

Description of Calculation Formula Using Elliptic Curve

The calculation using the elliptic curve is described next.

The elliptic curve is defined by
y²=x³+ax+b,

where the coordinates of arbitrary points P and Q are respectively (x₁, yᵢ) and (x₂, y₂). Here, the coordinates of a point R that is defined by “R=P+Q” are (x₃, y₃).

If P≠Q, “R=P+Q” becomes an add operation. The following are the formulas for the add operation.
x₃={(y₂−y₁)/(x₂−x₁)}²−x₁−x₂,
y₃={(y₂−y₁)/(x₂−x₁)}(x₁−x₃)−y₁.

If P=Q, R=P+Q=P+P=2×P. Therefore, “R=P+Q” becomes a double operation. The following are the formulas for the double operation;
x₃={(3x₁²+a)/2y₁}²−2x₁,
y₃={(3x₁²+a)/2y₁}(x₁−x₃)−y₁.

Note that the operations described above are operations on the finite field over which the elliptic curve is defined. The details of the calculation formula using the elliptic curve is described in “Efficient Elliptic Curve Exponentiation” in Miyaji, Ono and Cohen, Advances in Cryptology-Proceedings of ICICS'97, Lecture Notes in Computer Science, pp. 282-290, Springer-Verlag, 1997)

Service Subscription Request

The following describes the public key encryption unit 107 at the time when the terminal device 10 transmits the service subscription request to the server 30. The public key encryption unit 107 receives the random number R_0010 from the control unit 103, and stores therein the received random number. The random number R_0010 is a private key of the terminal device 10 itself, and used for establishing the SAC. Note that the random number R_0010 is stored in a secure area of the memory card 20, and it is read out from the control unit 103 via the memory card input/output unit 104. The public key encryption unit 107 uses the RSA cryptosystem as the algorithm for the public key cryptosystem, and establishes the SAC between the terminal device 10 and the server 30. The details are described later. Using the SAC, the public key encryption unit 107 receives system parameters for the elliptic curve “a₁, b₁, p₁, q₁, and G₁” from the server 30 via the network 60, the communication unit 101 and the control unit 103. As specific examples, the following values are given as the parameters.
a₁=−3
b₁=16461
p₁=20011
q₁=20023
G₁=(1, 7553).

Further, the public key encryption unit 107 generates the private key for service SK. The public key encryption unit 107 calculates a public key PK_A=SK*G₁(mod p₁) with use of the generated private key for service SK and the system parameters. The public key encryption unit 107 stores the generated SK in the memory card 20 via the control unit 103 and the memory card input/output unit 104, and transmits the calculated public key PK_A to the server 30 via the control unit 103, communication unit 101 and the network 60 with use of the SAC that is established with the server 30.

The following describe the public key encryption unit 107 at the time when the terminal device 10 transmits the service subscription request to the server 40. The public key encryption unit 107 receives the random number R_0010, which is the private key of the terminal device 10 itself, from the control unit 103, and establishes the SAC with the server 40 with use of the RSA cryptosystem. Upon establishing the SAC, the public key encryption unit 107 receives the private key for service SK from the control unit 103, and receives system parameters for the elliptic curve “a₂, b₂, p₂, q₂ and G₂” from the server 40 via the network 60, the communication unit 101 and the control unit 103 with use of the SAC that is established with the server 40.

As specific examples, the following values are given as the parameters.
a₂=−3
b₂=16461
p₂=20011
q₂=20023
G₂=(18892, 5928).

The public key encryption unit 107 calculates a public key PK_B=SK*G₂((mod p₂) based on the received SK and system parameters, and transmits the calculated public key PK_B to the server 40 via the control unit 103, the communication unit 101 and the network 60 with use of the SAC that is established with the server 40.

The following describe the public key encryption unit 107 at the time when the terminal device 10 transmits the service subscription request to the server 50. The public key encryption unit 107 receives the random number R_0010, which is the private key of the terminal device 10 itself, from the control unit 103, and establishes the SAC with the server 50 with use of the RSA cryptosystem. Upon establishing the SAC, the public key encryption unit 107 receives the SK from the control unit 103, and receives system parameters for the elliptic curve “a₃, b₃, p₃, q₃ and G₃” from the server 50 via the network 60, the communication unit 101 and the control unit 103 with use of the SAC that is established with the server 50. As specific examples, the following values are given as the parameters.
a₃=−3
b₃=116461
p₃=20011
q₃=20023
G₃=(8898, 13258).

The public key encryption unit 107 calculates a public key PK_C=SK*G₃ (mod p₃) based on the SK and the system parameters, and transmits the calculated public key PK_C to the server 50 via the control unit 103, the communication unit 101 and the network 60 with use of the SAC that is established with the server 50.

As described above, the terminal device 10 generates the three public keys PK_A, PK_B and PK_C which correspond to the servers on a one-to-one basis, with use of the one private key for service SK that is generated at the time of transmitting the service subscription request to the server 30 and the respective sets of system parameters received from the servers. Here, among the sets of system parameters respectively received from the servers, the base points G₁, G₂ and G₃ are different from each other, and therefore the three public keys generated by the terminal device 10 are different from each other.

Service Usage Request

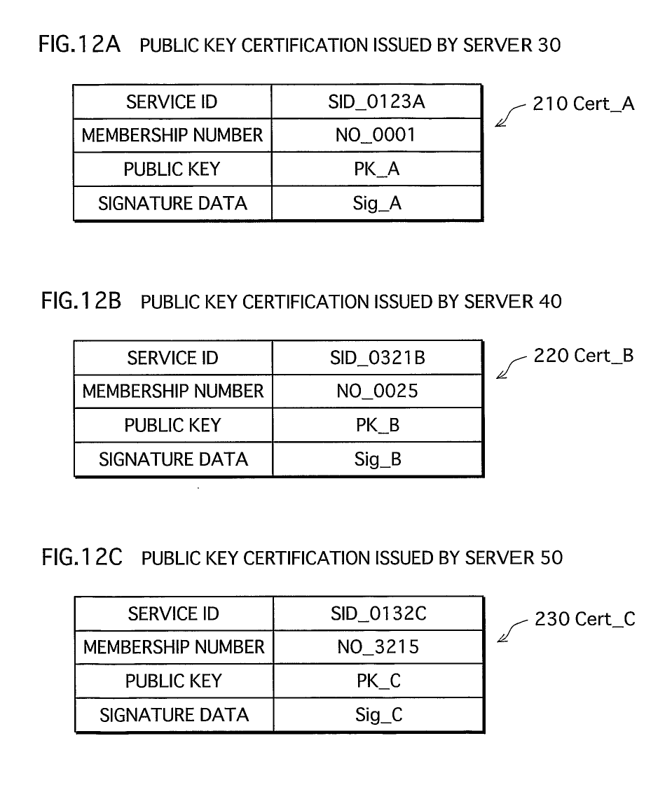

The following describe the public key encryption unit 107 at the time when the terminal device 10 transmits the service usage request to the server 30. The public key encryption unit 107 receives the SK, Cert_A and Pₖ_{_{—}}30 from the control unit 103, and establishes the SAC with the server 30 with use of the elliptic curve cryptosystem as the algorithm of the public key cryptosystem. The SK is a private key for service for the terminal device 10, and it is stored in the secure area of the memory card 20. The Cert_A, which is illustrated in FIG. 12A, is a public key certification issued to the terminal device 10 from the server 30. The Cert_A includes the public key PK_A that is released by the terminal device 10 to the server 30, and signature data generated by the server 30. The Cert_A is stored in a public key storage area 204c of the memory card 20. The Pₖ_{_{—}}30 is a public key of the server 30, and it is stored in the storage unit 108. The details of the processing for establishing the SAC are described later.

The following describe the public key encryption unit 107 at the time when the terminal device 10 transmits the service usage request to the server 40. The public key encryption unit 107 receives the SK, Cert_B and Pₖ_{_{—}}40 from the control unit 103, and establishes the SAC with the server 40 with use of the elliptic curve cryptosystem as the algorithm of the public key cryptosystem. The Cert_B, which is illustrated in FIG. 12B, is a public key certification issued to the terminal device 10 from the server 40. The Cert_B includes the public key PK_B that is released by the terminal device 10 to the server 40, and signature data generated by the server 40. The Cert_Bis stored in the public key storage area 204c of the memory card 20. The Pₖ_{_{—}}40 is a public key of the server 40, and it is stored in the storage unit 108.

The following describe the public key encryption unit 107 at the time when the terminal device 10 transmits the service usage request to the server 50. The public key encryption unit 107 receives the SK, the Cert_C and the Pₖ_{_{—}}50 from the control unit 103, and establishes the SAC with the server 50 with use of the elliptic curve cryptosystem as the algorithm of the public key cryptosystem. The Cert_C, which is illustrated in FIG. 12C, is a public key certification issued to the terminal device 10 from the server 50. The Cert_C includes the public key PK_C that is released by the terminal device 10 to the server 50, and signature data generated by the server 50. The Cert_C is stored in the public key storage area 204c of the memory card 20. The Pₖ_{_{—}}50 is a public key of the server 50, and it is stored in the storage unit 108.

(8) Storage Unit 108

The storage unit 108 receives the public keys Pₖ_{_{—}}30, Pₖ_{_{—}}40 and Pₖ_{_{—}}50 from the control unit 103, stores the received public keys. The Pₖ_{_{—}}30 is the public key of the server 30. The Pₖ_{_{—}}40 is the public key of the server 40. The Pₖ_{_{—}}50 is the public key of the server 50.

(9) Reproduction Unit 109

The reproduction unit 109 includes an audio recorder, a video recorder, a buffer, and so on. As shown in FIG. 2, the reproduction unit 109 is connected to an external output device, and outputs decoded contents to the external output device. The output device is, more specifically, a monitor and a speaker.

2. Memory Card 20

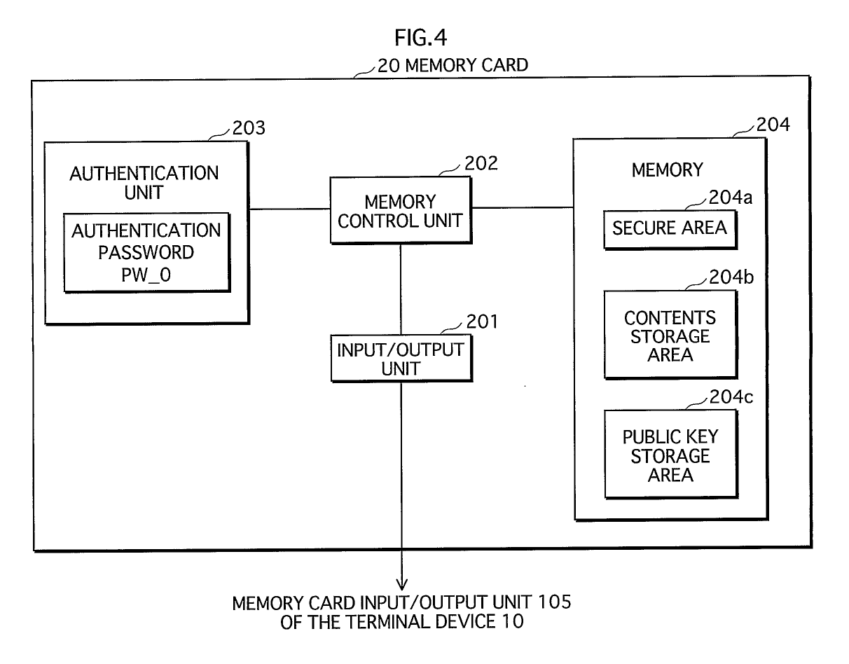

The memory card 20 is a memory that is in the shape of a card and uses a flash memory as a recording medium. FIG. 4 is a functional block diagram showing the structure of the memory cared 20 functionally. As shown in FIG. 4, the memory card 20 includes an input/output unit 201, a memory control unit 202, an authentication unit 203 and a memory 204.

(1) Input/Output Unit 201

The input/output unit 201 includes a plurality of pin terminals. In the state where the memory card 20 is inserted in the memory card input/output unit 104 of the terminal device 10, the input/output unit 201 outputs data received from the memory card input/output unit 104 to the memory control unit 202 and outputs data received from the memory control unit 202 to the memory card input/output unit 104 with use of the plurality of the pin terminals.

For instance, when the memory card 20 is inserted in the terminal device 10, the input/output unit 201 receives the memory card number “20”, that is stored in the authentication unit 203 via the memory control unit 202, and outputs the received memory card number “20” to the memory card input/output unit 104. The data that is transmitted or received by the input/output unit 201 is described later in the sections that describe the operations performed by the information security system 1.

(2) Memory Control Unit 202

The memory control unit 202 reads out data from the memory 204 according to instructions received from the terminal device 10 via the input/output unit 201. Then, the memory control unit 202 outputs the read-out data to the terminal device 10 via the input/output unit 201. The memory control unit 202 also receives data from the terminal device 10 via the input/output unit 201, and stores the received data in the memory 204.

The memory control unit 202 receives the random number R_0 from the terminal device 10 via the input/output unit 201, and outputs the received random number R_0 to the authentication unit 203. The memory control unit 202 also receives the encrypted text E2, and outputs the received E2 to the input/output unit 201 to the terminal device 10 via the input/output unit 201.

(3) Authentication Unit 203

The authentication unit 203 includes a microprocessor, a ROM, a RAM, and so on. The ROM or the RAM stores computer programs for the authentication, and the microprocessor executes the programs. Note that the ROM prestores the memory card number “20” and the authentication password “PW_0”. The memory card number “20” is used for identifying the memory card 20. The PW_0 is a secret data that is shared between the authentication unit 203 and the terminal device 10 and used for challenge-response type authentication performed between the authentication unit 203 and the memory card authentication unit 105 of the terminal device 10.

The authentication unit 203 receives the random number R_0 from the terminal device 10 via the input/output unit 201, and applies the encryption algorithm E to the authentication password PW_0 to generate the encrypted text E2, with use of the received random number R_0 as the private key. The authentication unit 203 outputs the generated encrypted text E2 to the terminal device 10 via the memory control unit 202 and the input/output unit 201.

Here, the encryption algorithm E is, for instance, a DES.

(4) Memory 204

The memory 204 is, more specifically, a storage device that is structured by an EEPROM and soon. The memory 204 includes a secure area 204a, a contents storage area 204b and the public key storage area 204c.

The secure area 204a is a temper-resistant storage area that is physically or logically protected against inside analysis and tampering. The secure area 204a stores therein the R_0010 that is the private key of the terminal device 10, and the private key for service SK. Note that the storage capacity of the secure area 204a is extremely small compared to the entire storage capacity of the memory 204.

The content storage area 204b stores the contents that are acquired by the terminal device 10 from the server 30, the server 40 and the server 50.

The public key storage area 204c stores therein the public key certification Cert_0010 acquired from the CA, the public key certification Cert_A acquired from the server 30, the public key certification Cert_B acquired from the server 40, and the public key certification Cert_C acquired from the server 50.

3. Server 30

The server 30 is a device that belongs to a contents provider. Upon receiving the service subscription request from the terminal device 10 that is connected to the server 30 via the network 60, the server 30 registers the terminal device 10. Upon receiving the service usage request from the terminal device 10 that is already registered, the server 30 provides contents to the terminal device 10.

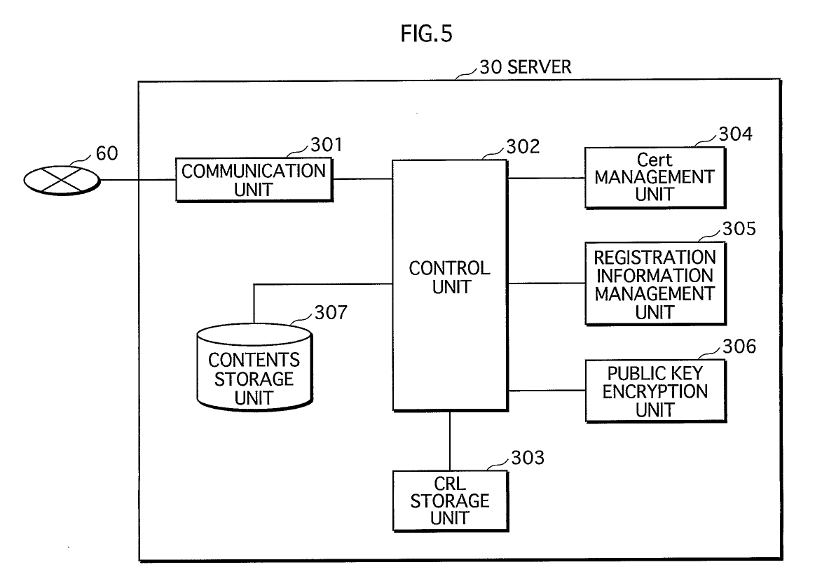

FIG. 5 is a functional block diagram that shows functionally shows the structure of the server 30. As shown in FIG. 5, the server 30 includes a communication unit 301, a control unit 302, a CRL storage unit 303, a Cert management unit 304, a registration information management unit 305, a public key encryption unit 306, and a contents storage unit 307.

The server 30 is, more specifically, a computer system that includes a microprocessor, a ROM, a RAM, a hard disk unit and so on.

(1) Communication Unit 301

The communication unit 301 is a unit that is used for a network connection and includes a Web browser. The communication unit 301 is connected to the terminal device 10 via the network 60.

The communication unit 301 receives information from the terminal device 10, and outputs the received information to the control unit 302. The communication unit 301 also receives information from the control unit 302 and outputs the received information to the terminal device 10.

The information that the communication unit 301 receives from the terminal device 10 is, more specifically, the public key PK_A, the signature data used for establishing the SAC, key information, and so on. The information that the communication unit 301 outputs to the terminal device 10 is, more specifically, the public key certification Cert_A, the signature data used for establishing the SAC, key information, the system parameters for the elliptic curve, contents, and so on.

Further, the communication unit 301 is connected to the CA via the network 60, and transmits/receives information to/from the CA in the following manner.

The communication unit 301 constantly receives up-to-data CRL from the CA via the network 60, and stores the received CRL in the CRL storage unit 303 via the control unit 302.

The communication unit 301 receives a public key “PK_0030” from the public key encryption unit 306 via the control unit 302, and outputs the received public key to the CA via the network 60. The communication unit 301 also receives a public key certification “Cert_0030” that corresponds to the public key “PK_0030” from the CA via the network 60, and outputs the received public key certification to the control unit 302.

The communication unit 301 acquires the system parameters for the elliptic curve from the CA via the network 60, and outputs the acquired system parameters to the control unit 302.

(2) Control Unit 302

The control unit 302 includes a microprocessor, a ROM, a RAM. The control unit 103 controls the entire server 30 with use of the microprocessor that executes computer programs.

(a) Before the control unit 302 communicates with the terminal device 10, a public key certification is issued to the control unit 302 by the CA. More specifically, the communication unit 301 transmits the public key “PK_0030” that is output by the public key encryption unit 306 and a device ID of the control unit 302 “ID_0030” that is prestored in the control unit 302 to the CA via communication unit 301. The control unit 302 receives the public key certification “Cert_0030” that corresponds to the public key “PK_0030” from the CA via the communication unit 301, and outputs the received public key certification to the Cert management unit 304.

(b) Upon receiving the service subscription request form the terminal device 10, the control unit 302 reads out the “Cert_0030” from the Cert management unit 304. Further, the control unit 302 outputs instructions to the public key encryption unit 306 to establish the SAC with the terminal device 10. After the SAC is established, the control unit 302 encrypts the system parameters for the elliptic curve “a₁, b₁, p₁, q₁ and G₁” with use of the session key received from the public key encryption unit 306. The system parameters are acquired from the CA. Then, the control unit 302 transmits the encrypted system parameters to the terminal device 10 via the communication unit 301 and the network 60.

As specific examples, the following values are given as the parameters.
a₁=−3
b₁=16461
p₁=20011
q₁=20023
G₁=(1, 7553).
(c) As a part of the processing for establishing the SAC, the control unit 302 reads out up-to-date CRL from the CRL storage unit 303, and judges whether the terminal device 10, which is the authentication target, is an invalidated device.
(d) Upon receiving the service usage request including the Cert_A from the terminal device 10, the control unit 302 judges whether the Cert_A is surely the public key certification issued to the terminal device 10 by the server 30 itself. Here, the control unit 302 refers to registration information that is managed by the registration information management unit 305. If the Cert_A received from the terminal device 10 is correct, the control unit 302 instructs the public key encryption unit 306 to establish the SAC.
(e) After the SAC between the server 30 and the terminal device 10 is established, for transmitting and receiving information to and from the terminal device 10, the control unit 302 receives the session key from the public key encryption unit 306. Using the received session key as an encryption key or a decryption key, the control unit 302 encrypts and transmits information to the terminal device 10, and decrypts the information received from the terminal device 10. For instance, after the SAC between the server 30 and the terminal device 10 is established for providing the services, the control unit 302 receives the session key from the public key encryption unit 306 and reads out the contents from the contents storage unit 307. The control unit 302 encrypts the read-out contents with use of the session key to generate encrypted contents, and transmits the generated encrypted contents to the terminal device 10 via the communication unit 301.
(3) CRL Storage Unit 303

The CRL storage unit 303 includes a RAM, and stores therein the CRL. The CRL is a list of IDs of invalidated devices, such as a device that has performed unauthorized operations and a device whose private key has been exposed. The CA transmits the CRL to the server 30 via the network 60. Here, the server 30 keeps the CRL received from the CA up to date all the time. The server 30 replaces the old CLR already stored in the CRL storage unit 303 with the up-to-date CRL. In the following descriptions, the CRL storage unit 303 stores the CRL 130 shown in FIG. 3B as the up-to-date CRL, as the CRL storage unit 106 of the terminal device 10 stores.

(4) Cert management Unit 304

The Cert management Unit 304 receives the public key certification Cert_0030 from the CA via the communication unit 301 and the control unit 302, and stores therein the received Cert_0030.

(5) Registration Information Management Unit 305

The registration information management unit 305 manages registration information regarding the terminal device to which the public key certification is issued by the public key encryption unit 306. The registration information includes the public key of a registered terminal device, a membership number that is allocated to the terminal device, information relating to the user, and so on. The registration information is used for managing the registered terminal device and user. The registration information is also used by the control unit 302 for verifying the Cert received from the terminal device 10.

(6) Public key Encryption Unit 306

The public key encryption unit 306 includes a microprocessor, a ROM, a RAM, and a random number generator.

Before the server 30 communicates with the terminal device 10, the public key encryption unit 306 generates the random number R_0030 with use of the random number generator, and generates the public key PK_0030 based on the generated random number R_0030. The public key encryption unit 306 transmits the generated public key PK_0030 to the CA via the control unit 302 and the communication unit 301.

Registration of Terminal Device 10

The public key encryption unit 306 generates a private key Kₛ_{_{—}}30, and receives the system parameters for the elliptic curve from the control unit 302. The public key encryption unit 306 calculates Kₚ_{_{—}}30=Kₛ_{_{—}}30*G₁(mod p₁) with use of the private key Kₛ_{_{—}}30 and the system parameters, and thereby generate a public key Kₚ_{_{—}}30. The public key encryption unit 306 outputs the generated public key Kₚ_{_{—}}30 to the control unit 302.

At the time of the service subscription and the registration, upon receiving the public key PK_A from the terminal device 10, the public key encryption unit 306 generates the public key certification Cert_A based on the received public key PK_A, and outputs the generated Cert_A to the control unit 302.

Providing Terminal Device 10 with Services

Upon receiving instructions from the control unit 302 to establish the SAC, the public key encryption unit 306 establishes the SAC with the terminal device 10, and generates the session key. The details of the SAC establishment are described later.

(7) Contents Storage Unit 307

The contents storage unit 307 is, more specifically, a hard disk drive unit that stores contents therein.

4. Server 40

The server 40 is a device that belongs to a contents provider, which is different from the contents provider that the server 30 belongs to. Upon receiving the service subscription request from the terminal device 10 that is connected to the server 40 via the network 60, the server 40 registers the terminal device 10. The server 40 also stores therein contents. Upon receiving the service usage request from the terminal device 10 that is already registered, the server 40 provides contents to the terminal device 10. The server 40 is, more specifically, a computer system that includes a microprocessor, a ROM, a RAM, a hard disk unit and so on. The structure of the server 40 is the same as the structure of the server 30 shown in FIG. 5. Therefore, the structure of the server 40 is not illustrated here. The following mainly describe the server 40 by focusing on the difference between the server 40 and the server 30.

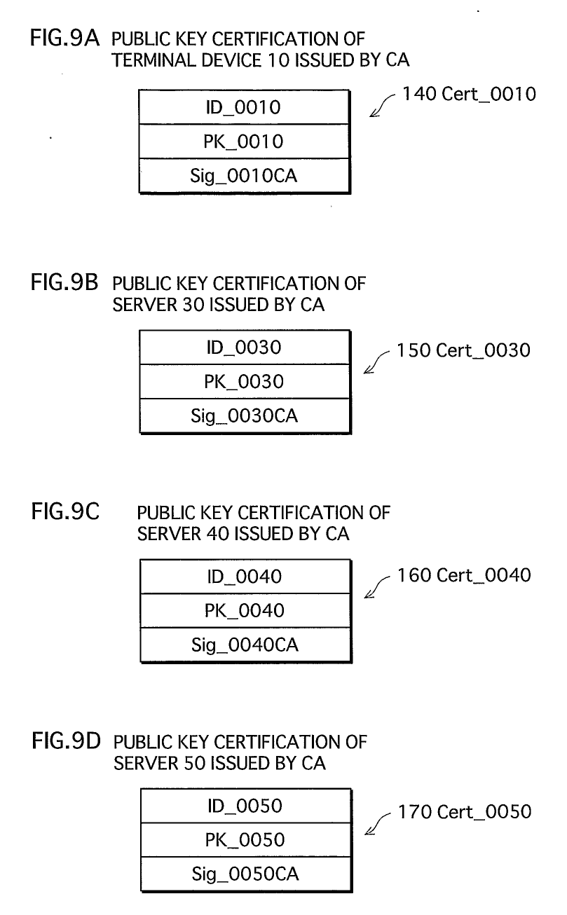

(a) Before communicating with the terminal device 10, the server 40 generates and transmits a public key PK_0040 to the CA, and a public key certification Cert_0040 is issued to the server 40 by the CA. The public key certification 160 in FIG. 9C shows the data structure of the Cert_0040. The Cert_0040 received from the CA is used for establishing the SAC between the terminal device 10 and the server 40.

(b) The server 40 receives the system parameters for the elliptic curves from the CA. Here, a set of the system parameters received by the server 40 is unique to the server 40.

More specifically, the server 40 receives the following system parameters:
a₂=−3
b₂=16461
p₂=20011
q₂=20023
G₂=(18892, 5928).

The server 40 generates a private key Kₛ_{_{—}}40, performs the elliptic curve calculation Kₚ_{_{—}}40=Kₛ_{_{—}}40*G₂(mod p₂) with use of the generated private key Kₛ_{_{—}}40 and the system parameters received from the CA, and thereby generates a public key Kₚ_{_{—}}40.

After establishing the SAC with the terminal device 10, the server 40 transmits the system parameters received from the CA and the generated public key Kₚ_{_{—}}40 to the terminal device 10.

(c) The server 40 receives the public key PK_B from the terminal device 10, and issues the public key certification Cert_B for the received public key PK_B. A public key certification 220, which is illustrated in FIG. 12B, shows the data structure of the Cert_B.

(d) Upon receiving the service usage request including the Cert_B from the terminal device 10, the server 40 verifies the Cert_B. If the verification of the Cert_B succeeds, the server 40 establishes the SAC with the terminal device 10, and outputs the contents to the terminal device 10.

5. Server 50

The server 50 is a device that belongs to a contents provider, which is different from the respective contents providers that the server 30 and the server 40 belong to. Upon receiving the service subscription request from the terminal device 10 that is connected to the server 50 via the network 60, the server 50 registers the terminal device 10. The server 50 also stores therein contents. Upon receiving the service usage request from the terminal device 10 that is already registered, the server 50 provides contents to the terminal device 10. The server 50 is, more specifically, a computer system that includes a microprocessor, a ROM, a RAM, a hard disk unit and so on. The structure of the server 50 is the same as the structure of the server 30 shown in FIG. 5. Therefore, the structure of the server 50 is not illustrated here. The following describe the server 50 by focusing on the difference between the server 50 and the servers 30 and 40.

(a) Before communicating with the terminal device 10, the server 50 generates and transmits a public key PK_0050 to the CA, and a public key certification Cert_0050 is issued to the server 50 by the CA. The public key certification 170 in FIG. 9D shows the data structure of the Cert_0050. The Cert_0050 received from the CA is used for establishing the SAC with the terminal device 10.

(b) The server 50 receives the system parameters for the elliptic curves from the CA. Here, a set of the system parameters received by the server 50 is unique to the server 50.

More specifically, the server 50 receives the following system parameters:
A₃=−3
B₃=16461
P₃=20011
Q₃=20023
G₃=(8898, 13258).

The server 40 generates a private key Kₛ_{_{—}}50, performs the elliptic curve calculation Kₚ_{_{—}}50=Kₛ_{_{—}}50*G₃(mod p₃) with use of the generated private key Kₛ_{_{—}}50 and the system parameters received from the CA, and thereby generates a public key Kₚ_{_{—}}50.

After establishing the SAC with the terminal device 10, the server 50 transmits the system parameters received from the CA and the generated public key Kₚ_{_{—}}50 to the terminal device 10.

(c) The server 50 receives the public key PK_C from the terminal device 10, and issues the public key certification Cert_C for the received public key PK_C. A public key certification 230, which is illustrated in FIG. 12C, shows the data structure of the Cert_C.

(d) Upon receiving the service usage request including the Cert_C from the terminal device 10, the server 50 verifies the Cert_C. If the verification of the Cert_C succeeds, the server 50 establishes the SAC with the terminal device 10, and outputs the contents to the terminal device 10.

Operations

Operations performed by the information security system 1 are described next.

(1) Operations by Entire System (for Service Subscription and Registration)

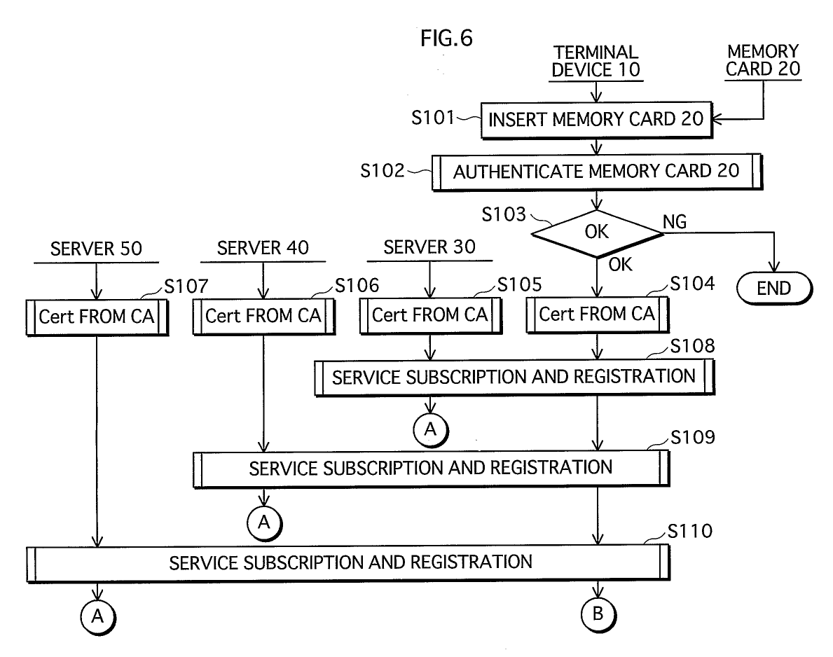

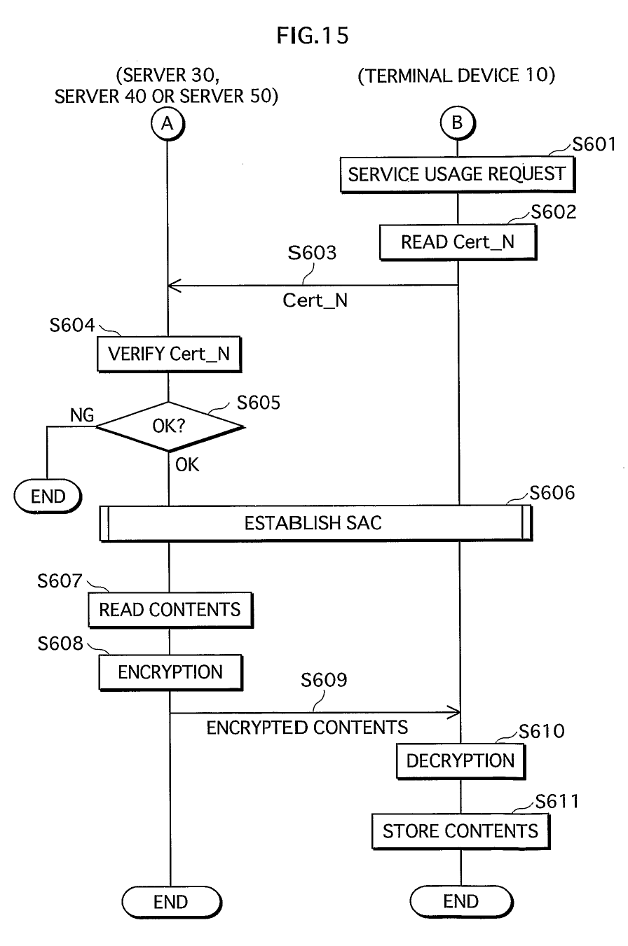

FIG. 6 and FIG. 15 are flowcharts that show the operation by the entire information security system 1. FIG. 6 shows the operations by the information security system 1 at the time of the service subscription and “the registration”. FIG. 15 shows the operations by the information security system 1 at the time of “the service usage”.

Firstly, when the memory card 20 is inserted into the memory card input/output unit 104 of the terminal device 10 (Step S101), the terminal device 10 authenticates the memory card 20 (Step S102). If the authentication of the memory card 20 fails (NG in Step S103), the terminal device 10 finishes the processing. If the authentication of the memory card 20 succeeds (OK in Step S103), the public key certification is issued by the CA to the terminal device 10 (Step S104).

The public key certification is previously issued by the CA to the server 30 (Step S105). In the same way, the public key certification is previously issued by the CA to the server 40 (Step S106). In the same way, the public key certification is previously issued by the CA to the server 50 (Step S107).

Next, the terminal device 10 and the server 30 perform the service subscription and the registration (Step S108). Next, the terminal device 10 and the server 40 perform the service subscription and the registration (Step S109). Next, the terminal device 10 and the server 50 perform the service subscription and the registration (Step S110).

These are the processing for “the service subscription” and “the registration”.

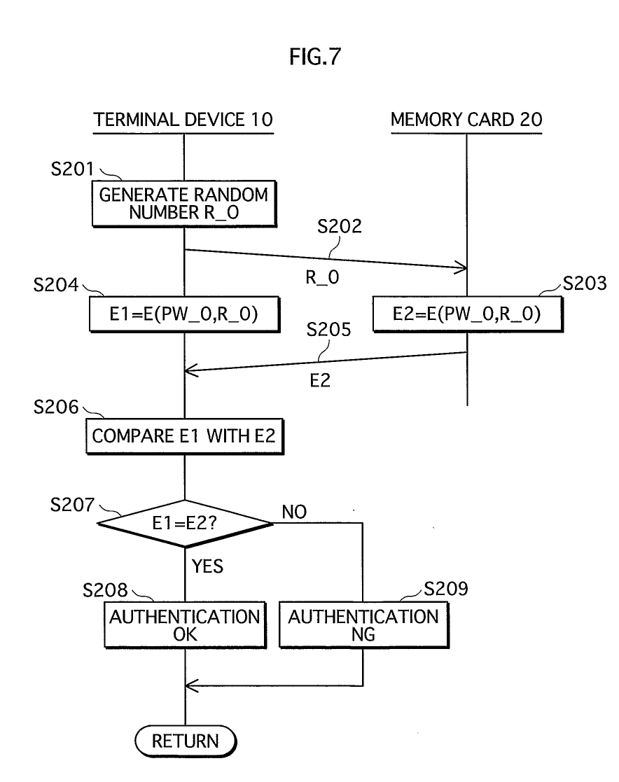

The processing is continued to FIG. 15. However, for the sake of convenience, the details of the processing for the service subscription and the registration are described first with reference to the flowcharts in FIG. 7 and later, and then, FIG. 15 is described.

(2) Authentication of Memory Card 20

Here, the authentication of the memory card 20 is described, with reference to the flowchart shown in FIG. 7. Note that the details of the operations performed in Step S102 in FIG. 6 are described here.

In the state where the memory card 20 is inserted in the memory card input/output unit 104 of the terminal device 10, the memory cared authentication unit 105 of the terminal device 10 generates the random number R_0 (Step S201) and holds therein the generated random number R_0. At the same time, the memory card authentication unit 105 also outputs the generated random number R_0 to the memory cared 20 via the memory card input/output unit 104, and the memory card 20 receives the random number R_0 (Step S202).

Upon receiving the random number R_0 via the input/output unit 201 and the memory control unit 202, the authentication unit 203 of the memory card 20 applies the encryption algorithm E to the authentication password PW_0, which is stored in the authentication unit 203, to generate the encrypted text E2, with use of the random number R_0 as the encryption key (Step S203). Meanwhile, the memory card authentication unit 105 applies the encryption algorithm E to the authentication password PW_0, which is shared between the memory card 20 and the memory card authentication unit 105, to generate the encrypted text E1, with use of the random number R_0 that is generated in Step S201 as the private key (Step S204).

The authentication unit 203 of the memory card 20 transmits the encrypted text E2, which is generated in Step S203, to the terminal device 10, and the terminal device 10 receives the encrypted text E2 (Step S205). The memory card authentication unit 105 of the terminal device 10 receives the encrypted text E2 via the memory card input/output unit 104 and the control unit 103, and compares the received encrypted text E2 to the encrypted text E1 which is generated in Step S204 (Step S206).

If the encrypted text E1 is the same as the encrypted text E2 (YES in Step S207), this means that the terminal device 10 has succeeded to authenticate the memory card 20, and the memory card authentication unit 105 outputs a signal representing “authentication OK” to the control unit 103 (Step S208). Then, the terminal device 10 goes back to Step S103 in FIG. 6, and continues the processing.

If the encrypted text E1 is not the same as the encrypted text E2 (NO in Step S207), this means that the terminal device 10 has failed to authenticate the memory card 20, and the memory card authentication unit 105 outputs a signal representing “authentication NG” to the control unit 103 (Step S209). Then, the terminal device 10 goes back to Step S103 in FIG. 6, and continues the processing.

(3) Processing for Receiving Public Key Certification (Cert) from CA

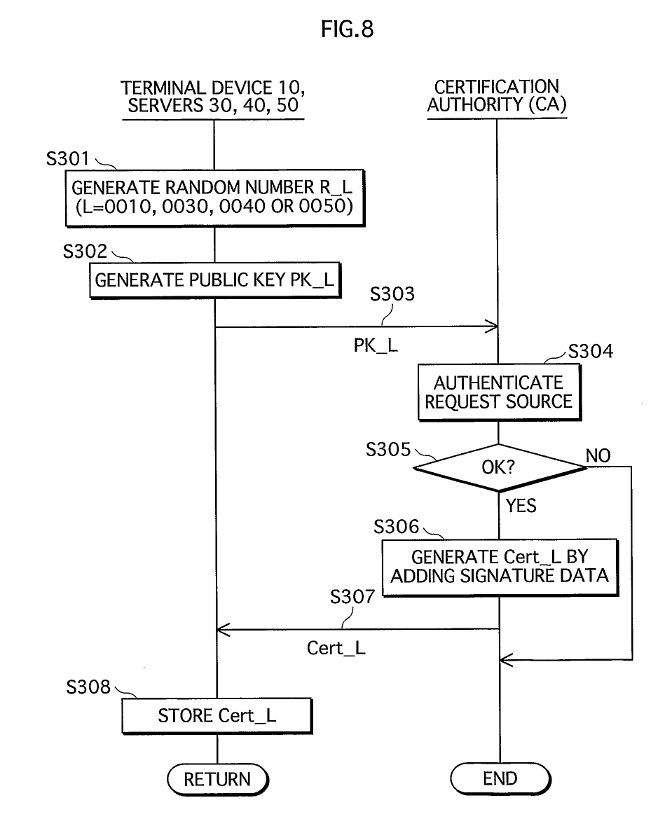

Here, the processing for the terminal device 10 and the servers 30, 40 and 50 to respectively receive the public key certifications from the CA is described with use reference to the flowchart shown in FIG. 8. Note that the details of the operations performed in Steps 104, 105, 106 and 107 in FIG. 6 are described here.

The public key encryption unit of each of the terminal device 10 and servers 30, 40 and 50 generates a random number R_L by the random number generator of each (Step S301), and further generates a public key PK_L from the generated random number R_L (Step S302). Here, L=0010 is given for the terminal device 10, L=0030 is given for the server 30, L-0040 is given for the server 40 and L=0050 is given for the server 50. Note that an algorithm used for generating the public key PK_L from the random number R_L is not limited here. As an example, the RSA cryptosystem may be used.

The public key encryption unit of each of the terminal device 10 and servers 30, 40 and 50 outputs the generated public key PK_L to each control unit. Each control unit transmits the public key PK_L and the information that includes the device ID of the control unit itself and stored in the control unit, to the CA via the communication unit. The CA receives the public key PK_L and information that includes the device ID from each. (Step S303).

As to the source of the information received in Step S303 (request source of the public key certification), the CA verifies the existence and correctness of the public key, the mail address, the user, and the organization that the user belongs to (Step S304).

If the request source is not authorized (NO in Step S305), the CA finishes the processing.

If the request source is authorized, (YES in Step S305), the CA adds signature data Sig_LCA to the received public key PK_L and device ID, and generates a public key certification Cert_L (Step S306). The CA transmits the generated public key certification Cert_L to each of the request sources, namely the terminal device 10 and the servers 30, 40 and 50. Each of the terminal device 10 and the servers 30, 40 and 50 receives the public key certification Cert_L (Step S307).

The terminal device 10 stores the received public key certification Cert_0010 in the public key storage are 204c of the memory card 20 via the control unit 103 and the memory card input/output unit 104 (Step S308). Here, the data structure of the public key certification Cert_0010, which the terminal device 10 receives from the CA, is shown in FIG. 9A. As shown in FIG. 9A, the Cert_0010 includes the ID_0010, the PK_0010 and the Sig_0010CA. Note that the ID_0010 is the device ID of the terminal device 10.

The server 30 stores the public key certification Cert_0030 received in Step S307 in the Cert management unit 304 via the control unit 302 (Step S308). FIG. 9B shows the data structure of the public key certification Cert_0030 that the server 30 receives from the CA. As shown in FIG. 9B, the Cert_0030 includes the ID_0030, the PK_0030 and the Sig_0030CA. Note that the ID_0030 is the device ID of the server 30.

In the same way, the server 40 and the server 50 store the public key certifications Cert_0040 and the Cert_0050 inside respectively (Step S308). FIG. 9C shows the data structure of the public key certification Cert_0040 that the server 40 receives from the CA. FIG. 9D shows the data structure of the public key certification “Cert_0050 that the server 50 receives from the CA.

Upon receiving the public key certification from the CA, the terminal device 10 and the server 30 start the processing in Step S108. The server 40 starts the processing in Step S109, and the server 50 starts the processing in Step S110.

(4) Service Subscription and Registration

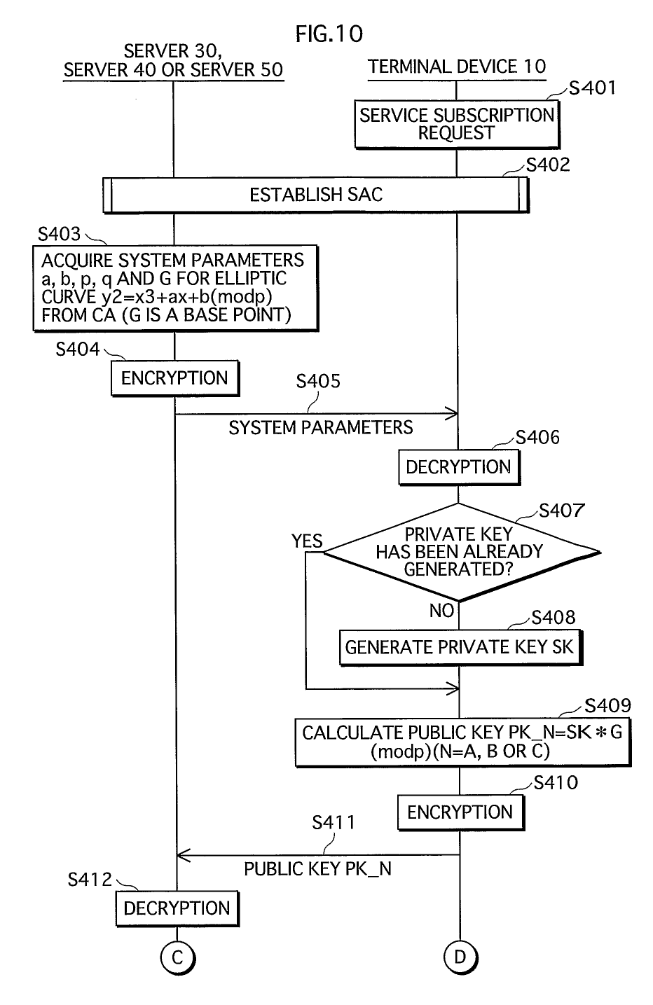

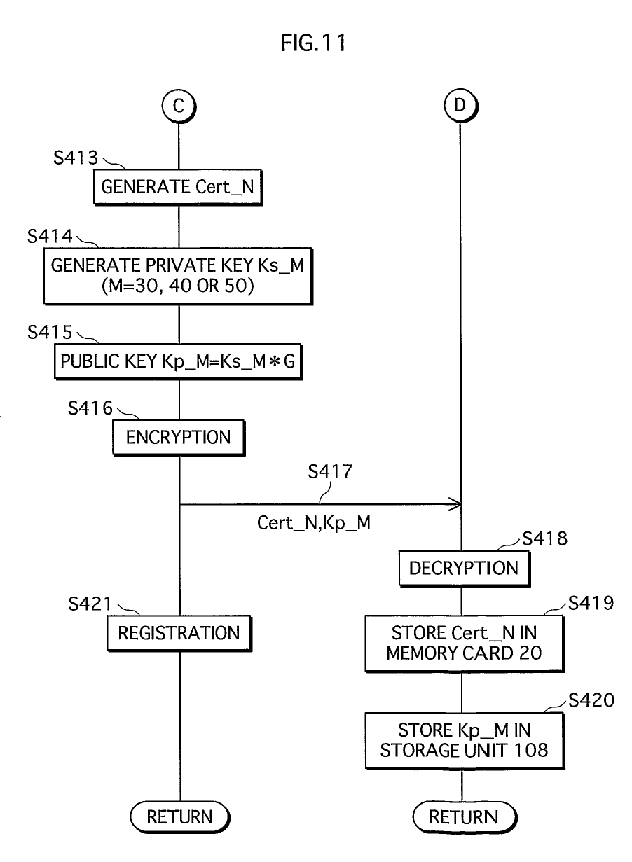

With reference to the flowcharts shown in FIG. 10 and FIG. 11, the following describe the service subscription and the registration between the terminal device 10 and the server 30 (Step S108 in FIG. 6), the service subscription and the registration between the terminal device 10 and the server 40 (Step S109 in FIG. 6), and the service subscription and the registration between the terminal device 10 and the server 50 (Step S110 in FIG. 6). In this section, each of the servers 30, 40 and 50 is sometimes simply called “the server”.

After the service subscription request is caused to the server by the terminal device 10 receiving an input from the user via the operation input unit 102 (Step S401), the SAC is established between the terminal device 10 and the server (Step S402).

The server receives the system parameters for the elliptic curve from the CA (Step S403). Here, the system parameters that the server 30 acquires from the CA are “a₁, b₁, p₁, q₁ and G₁”, and the system parameters that the server 40 acquires from the CA are “a₂, b₂, p₂, q₂ and G₂”, and the system parameters that the server 40 acquires from the CA are “a₃, b₃, p₃, q₃ and G₃”.

The control unit of the server encrypts the acquired system parameters with use of the session key as the encryption key, which is shared between the terminal device 10 and the server in the SAC establishment processing in Step S402 (Step S404). Note that the encryption algorithm used here is, for instance, the DES (Data Encryption Standard). The control unit of the server transmits the encrypted system parameters to the terminal device via the communication unit and the network 60, and the communication unit 101 of the terminal device 10 receives the system parameters (Step S405).

The control unit 103 of the terminal device 10 decrypts the encrypted system parameters with use of the session key as the decryption key, which is shared between the terminal device 10 and the server in the SAC establishment processing in Step S402 (Step S406). If the public key encryption unit 107 of the terminal device 10 has already generated the private key for service SK, and the secure area 204a of the memory card 20 stores the SK (YES in Step S407), the processing goes to Step S409. If the public key encryption unit 107 of the terminal device 10 has not generated the private key for service SK yet, and the secure area 104a of the memory card 20 does not store the SK (NO in Step S407), the public key encryption unit 107 generates the private key for service with the random number generator (Step S408).

The public key encryption unit 107 generates a public key PK_N by calculating the next equation with use of the private key for service SK and the system parameters acquired from the server (Step S409).

PK_{—}N=SK*G(mod p), where N=A,B and C.

Note that private key for service SK is the key data generated in Step S408, or the key data that has been already generated and stored in the secure area 204a of the memory card 20.

The PK_A is the public key that is generated based on the system parameters received from the server 30. The PK_B is the public key that is generated based on the system parameters received from the server 40. The PK_C is the public key that is generated based on the system parameters received from the server 50.

Next, the control unit 103 of the terminal device 10 encrypts the generated public key PK_N with user of the session key as the encryption key (Step S410) and transmits the encrypted PK_N to the server via the communication unit 101 and the network 60, and the communication unit of the server receives the encrypted public key PK_N. (Step S411). The control unit of the server decrypts the encrypted public key PK_N with use of the session key (Step S412).

Next, the public key encryption unit of the server generates a public key certification Cert_N for the public key PK_N received from the terminal device 10 (Step S413). Then, the public key encryption unit generates a private key Kₛ_{_{—}}M (M=30, 40 and 50) with use of the random number generator, and calculates a public key Kₚ_{_{—}}M=Kₛ_{_{—}}M*G based on the generated private key Kₛ_{_{—}}M (Step S415). The sign G represents the base point of the elliptic curve. The control unit of the server encrypts the public key certification Cert_N and the public key Kₚ_{_{—}}M with use of the session key as the encryption key and transmits the encrypted Cert_N and Kₛ_{_{—}}M to the terminal device 10 via the communication unit and the network 60, and the communication unit 101 of the terminal device 10 receives the encrypted Cert_N and Kₚ_{_{—}}M (Step S417).

The control unit 103 of the terminal device 10 decrypts the received Cert_N and Kₚ_{_{—}}M with use of the session key (Step S418), stores the decrypted public key certification Cert_N in the secure area 204a of the memory card 20 via the memory card input/output unit 104 (Step S419) and stores the public key Kₚ_{_{—}}M of the server in the storage unit 108 (Step S420).

Meanwhile, the registration information management unit of the server generates the registration information regarding the terminal device 10 and manages the registration information (Step S421). The registration information includes the public key of the terminal device and the membership number allocated to the terminal device 10, and so on.

The public key certification Cert_N, which each server generates and issues to the terminal device 10, is described next, with reference to FIG. 12.

FIG. 12A shows the data structure of the Cert_A, which is issued by the server 30 to the terminal device 10. As shown in FIG. 12A, the Cert_A includes a service ID “SID_0123A”, a membership number “NO_0001”, a public key “PK_A” and signature data “Sig_A”.

The service ID “SID_0123A” represents a type of the service that the terminal device 10 used among the services that the server 30 provides. The membership number “NO_0001” is the number allocated to the terminal device in order to identify the terminal device from a plurality of terminal devices that are registered at the server 30. The public key “PK_A” is the key data generated by the terminal device 10 based on the system parameters for the elliptic curve, which are received from the server 30, and the private key for service SK. The signature data “Sig_A” is data that the server 30 generates by applying the signature algorithm to the “SID_0123A”, the “NO_0001” and the “PK_A”.

FIG. 12B shows the data structure of the Cert_B, which is issued by the server 40 to the terminal device 10. As shown in FIG. 12B, the Cert_B includes a service ID “SID_0321B”, a membership number “NO_0025”, a public key “PK_B” and signature data “Sig_B”.

The service ID “SID_0321B” represents a type of the service that the terminal device 10 used among the services that the server 40 provides. The membership number “NO_0025” is the number allocated to the terminal device in order to identify the terminal device from a plurality of terminal devices that are registered at the server 40. The public key “PK_B” is the key data generated by the terminal device 10 based on the system parameters for the elliptic curve, which are received from the server 40, and the private key for service SK. The signature data “Sig_B” is data that the server 40 generates by applying the signature algorithm to the “SID_0321B”, the “NO_0025” and the “PK_B”.

FIG. 12C shows the data structure of the Cert_C, which is issued by the server 50 to the terminal device 10. As shown in FIG. 12C, the Cert_C includes a service ID “SID_0132C”, a membership number “NO_3215”, a public key “PK_C” and signature data “Sig_C”.

The service ID “SID_0132C” represents a type of the service that the terminal device 10 used among the services that the server 50 provides. The membership number “NO_3215” is the number allocated to the terminal device in order to identify the terminal device from a plurality of terminal devices that are registered at the server 50. The public key “PK_C” is the key data generated by the terminal device 10 based on the system parameters for the elliptic curve, which are received from the server 50, and the private key for service SK. The signature data “Sig_C” is data that the server 50 generates by applying the signature algorithm to the “SID_0132C”, the “NO_3215” and the “PK_C”.

(5) Establishment of SAC 1

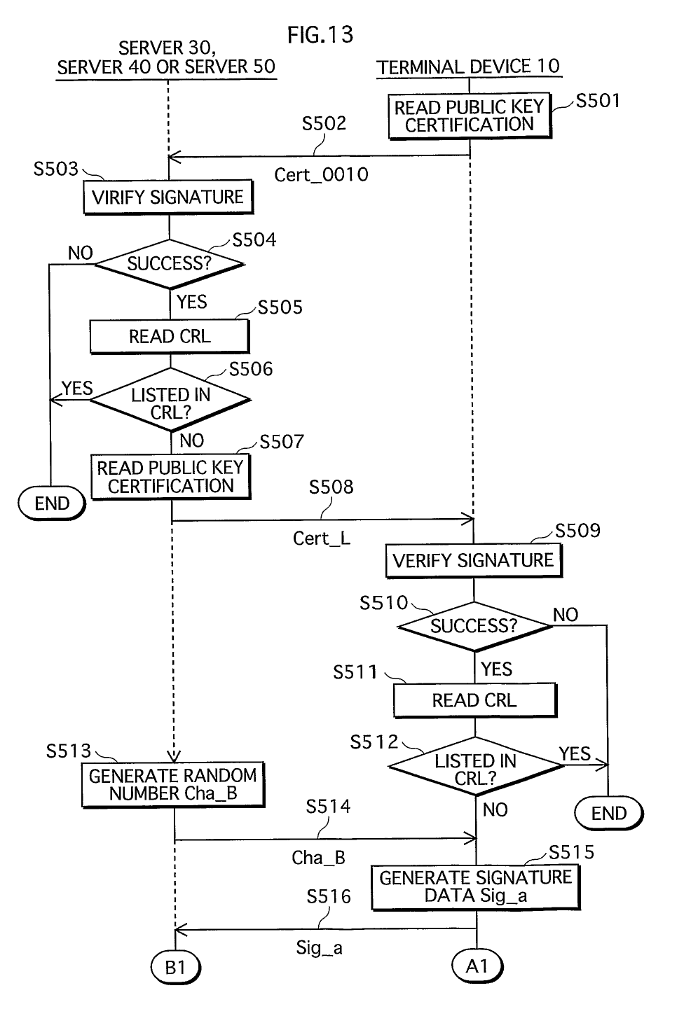

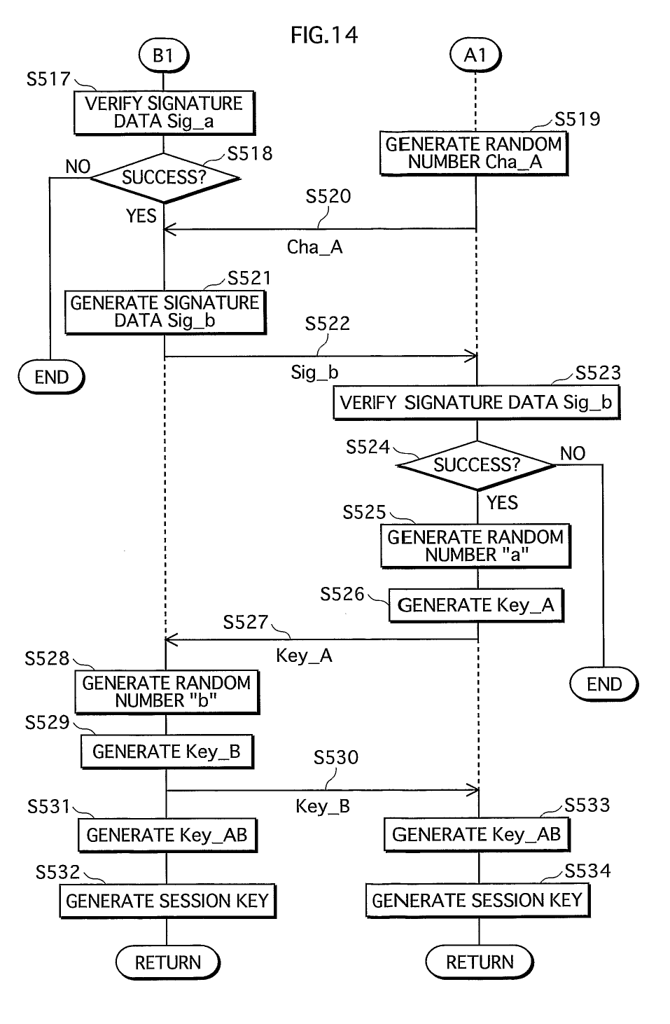

Here, the operations for establishing the SAC between the terminal device 10 and each server at the time of the service subscription and the registration are described, with reference to the flowcharts shown in FIG. 13 and FIG. 14. Note that the details of Step S402 in FIG. 10 are described here.

Here, Gen( ) is a key generation function, and Y is a parameter unique to the system. Gen (X, Gen (Y, Z))=Gen (Y, Gen (X, Z)) is satisfied. The key generation function is not described here, because it can be realized with a technique in the public domain.

First, the control unit 103 of the terminal device 10 reads out the public key certification Cert_0010 from the memory card 20 via the memory card input/output unit 104 (Step S501). The communication unit 101 of the terminal device 10 transmits the Cert_0010 to the server via the network 60, and the communication unit of the server receives the Cert_0010 (Step S502). The server applies a signature verification algorithm to the signature data Sig_0010CA included in the public key certification Cert_0010 with use of a public key PK_CA of the CA (Step S503). Here, assume that the public key PK_CA of the CA is already known by the server. If the verification fails (NO in Step S504), the server finishes the processing. If the verification succeeds (YES in Step S504), the control unit of the server reads out the CRL from the CRL storage unit (Step S505), and judges whether the ID_0010 included in the public key certification Cert_0010 is listed in the CRL.

If it is judged that the ID_0010 is listed in the CRL (YES in Step S506), the server finishes the processing. If it is judged that the ID_0010 is not listed in the CRL (NO in Step S506), the control unit of the server reads out the public key certification Cert_L from the Cert management unit (Step S507). The control unit transmits the public key certification Cert_L to the terminal device 10 via the communication unit and the network 60, and the communication unit of the terminal device 10 receives the Cert_L (Step S508).

Upon receiving the public key certification Cert_L, the control unit 103 of the terminal device 10 applies a signature verification algorithm to the signature data Sig_LCA included in the Cert_L with use of a public key PK_CA of the CA (Step S509). Here, assume that the public key PK_CA of the CA is already known by the terminal device 10. If the verification fails (NO in Step S510), the terminal device 10 finishes the processing. If the verification succeeds (YES in Step S510), the control unit 103 reads out the CRL from the CRL storage unit 106 (Step S511), and judges whether the received ID_L that is included in the public key certification Cert_L is listed in the CRL.

If it is judged that the ID_L is listed in the CRL (YES in Step S512), the terminal device 10 finishes the processing. If it is judged that the ID_L is not listed in the CRL (NO in Step S512), the terminal device 10 continues the processing.

After the processing in Step S507, the public key encryption unit of the server generates a random number Cha_B (Step S513). The communication unit of the server transmits the random number Cha_B to the terminal device 10 via the network 60, and the communication unit 101 of the terminal device 10 receives the random number Cha_B (Step S514).

Upon receiving the random number Cha_B, the control unit 103 of the terminal device 10 reads out the private key R_0010 from the secure area 204a of the memory card 20 via the memory card input/output unit 104, and outputs the read-out private key R_0010 and the received random number Cha_B to the public key encryption unit 107. The public key encryption unit 107 applies the signature algorithm to the random number Cha_B with use of the private key R_0010, to generate the signature data Sig_a (Step S515). The communication unit 101 transmits the signature data Sig_a generated by the public key encryption unit 107 to the server via the network 60, and the communication unit of the server receives the signature data Sig_a (Step S516).

Upon receiving the signature data Sig_a via the control unit, the public key encryption unit of the server applies the signature verification algorithm to the signature data Sig_a with use of the public key PK_0010 that is included in the Cert_0010 and received in Step S502 (Step S517). If the verification fails (NO in Step S518), the server finishes the processing. If the verification succeeds (YES in Step S518), the server continues the processing.

Meanwhile, following the processing in Step S515, the terminal device 10 generates the random number Cha_A by the public key encryption unit 107 (Step S519). The public key encryption unit 107 transmits the generated random number Cha_A to the server via the control unit 103, the communication unit 101 and the network 60, and the communication unit of the server receives the random number Cha_A (Step S520).

The control unit of the server outputs the received random number Cha_A to the public key encryption unit, and the public key encryption unit applies the signature algorithm to the received random number Cha_A with use of the private key R_L that is stored inside the public key encryption unit, and thereby generate the signature data Sig_b (Step S521). The server transmits the generated signature data Sig_b to the terminal device 10 via the control unit, the communication unit and the network 60, and the communication unit 101 of the terminal device 10 receives the signature data Sig_b (Step S522).

Upon receiving the signature data Sig_b via the control unit 103, the public key encryption unit 107 of the terminal device 10 applies the signature verification algorithm to the signature data Sig_b with use of the public key PK_L that is included in the Cert_L and received in Step S508 (Step S523). If the verification fails (NO in Step S524), the terminal device 10 finishes the processing. If the verification succeeds (YES in Step S524), the public key encryption unit 107 of the terminal device 10 generates a random number “a” (Step S525), and generates Key_A=Gen (a, Y) with use of the generated random number “a” (Step S526). The communication unit 101 of the terminal device 10 transmits the Key_A generated by the public key encryption unit 107 to the server via the network 60, and the communication unit of the server receives the Key_A (Step S527).

Upon receiving the Key_A, the public key encryption unit of the server generates a random number “b” (Step S528), and generates Key_B=Gen (b, Y) with use of the generated random number “b” (Step S529). The communication unit of the server transmits the Key_B generated by the public key encryption unit to the terminal device 10 via the network 60, and the communication unit of the terminal device 10 receives the Key_B (Step S530). The public key encryption unit of the server also generates Key_AB=Gen(b, Key_A)=Gen(b, Gen(a, Y)) with use of the random number “b” generated in Step S528 and the Key_A received in Step S527 (Step S531), and outputs the generated Key_AB to the control unit as the session key (Step S532).

Then, the server goes back to Step S403 shown in FIG. 10, and continues the processing.

Meanwhile, upon receiving the Key_B in Step S530, the public key encryption unit 107 of the terminal device 10 generates Key_AB=Gen(a, Key_B)=Gen(a, Gen(b, Y)) based on the Key_B and the random number “a” that is generated in Step S525, and outputs the generated Key_AB as the session key to the control unit 103 (Step S534). Then, the terminal device 10 goes back to Step S406 in FIG. 10 and continues the processing.

(6) Operations by Entire System 2 (for Service Usage)

The operations performed by the entire information security system 1 are described next with reference to the flowchart shown in FIG. 15, which is continued from FIG. 6. Note that the operations shown in FIG. 15 are the operations for the “service usage” among the operations performed by the entire information security system 1. In this section, each of the servers 30, 40 and 50 is sometimes simply called “the server”.

After the service usage request is caused to the server by the terminal device 10 receiving an input from the user via the operation input unit 102 (Step S601), the control unit 103 reads out the public key certification Cert_N(N=A, B or C) that is generated by the server specified by the user, from the secure area 204a of the memory card 20 via the memory card input/output unit 104 (Step S602). The control unit 103 transmits the read-out public key certification Cert_N to the specified server via the communication unit 101 and the network 60, and the communication unit of the server receives the public key certification Cert_N (Step S603).

Upon receiving the public key certification Cert_N, the control unit of the server judges whether the received Cert_N is correct in the following manner (Step S604). The control unit reads out the registration information corresponding to the terminal device 10 from the registration management unit, and judges whether the service ID, the membership number and the public key of the terminal device 10 are the same as the registered information. Further, the control unit outputs the signature data Sig_N included in the Cert_N to the public key encryption unit. Upon receiving the Sig_N, the public key encryption unit applies the signature verification algorithm to the received Sig_N to verify the Sig_N, and outputs the verification result.

If the verification of the Cert_N fails (NG in Step S605), the server finishes the processing. If the verification of the Cert_N succeeds (OK in Step S605), the server and the terminal device 10 perform processing for establishing the SAC (Step S606).

After the SAC is established with the terminal device 10, the control unit of the server reads out the contents from the contents storage unit (Step S607), and encrypts the read-out contents with use of the session key as the encryption key, which is shared with the terminal device 10 in Step S606 (Step S608). The encryption algorithm used here is, for instance, the DES. The communication unit of the server transmits the encrypted contents to the terminal device 10 via the network 60, and the communication unit 101 of the terminal device 10 receives the encrypted contents (Step S609).

Upon receiving the encrypted contents, the control unit 103 of the terminal device 10 decrypts the received contents with use of the session key as the decrypt key, which is shared with the server in Step S606 (Step S610). The control unit 103 stores the decrypted contents in the contents storage area 204b of the memory card 20 via the memory card input/output unit 104 (Step S611).

(7) Establishment of SAC 2

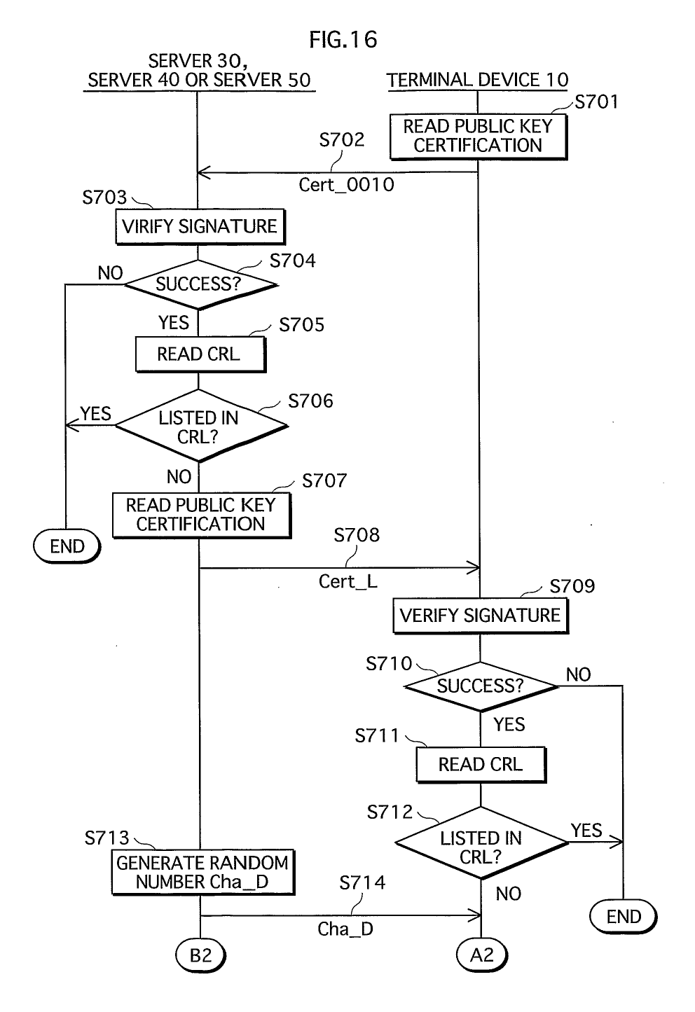

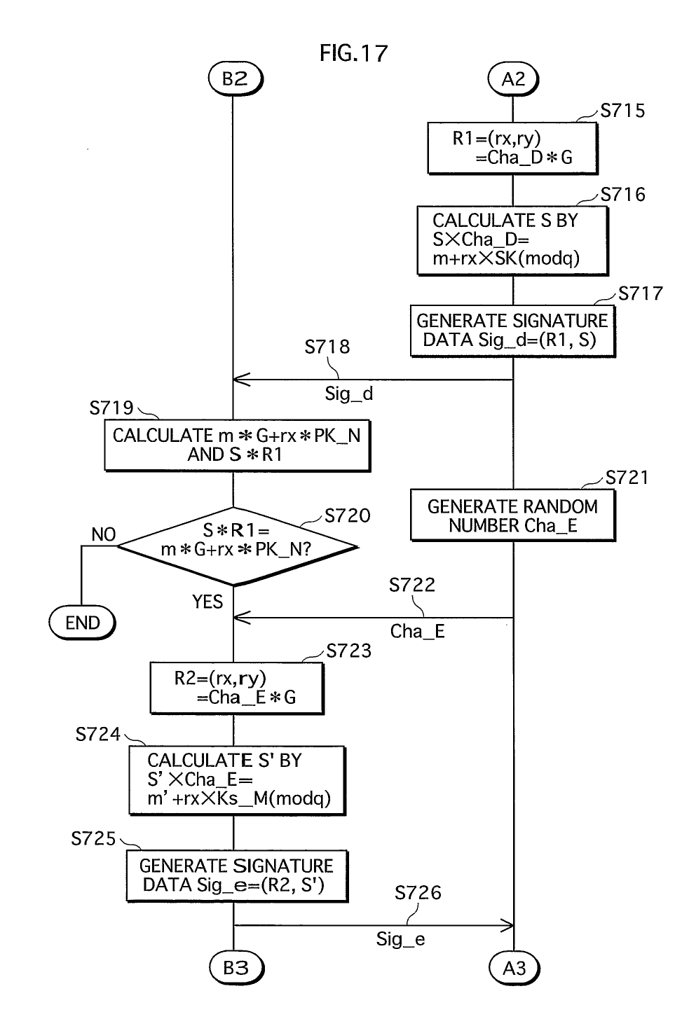

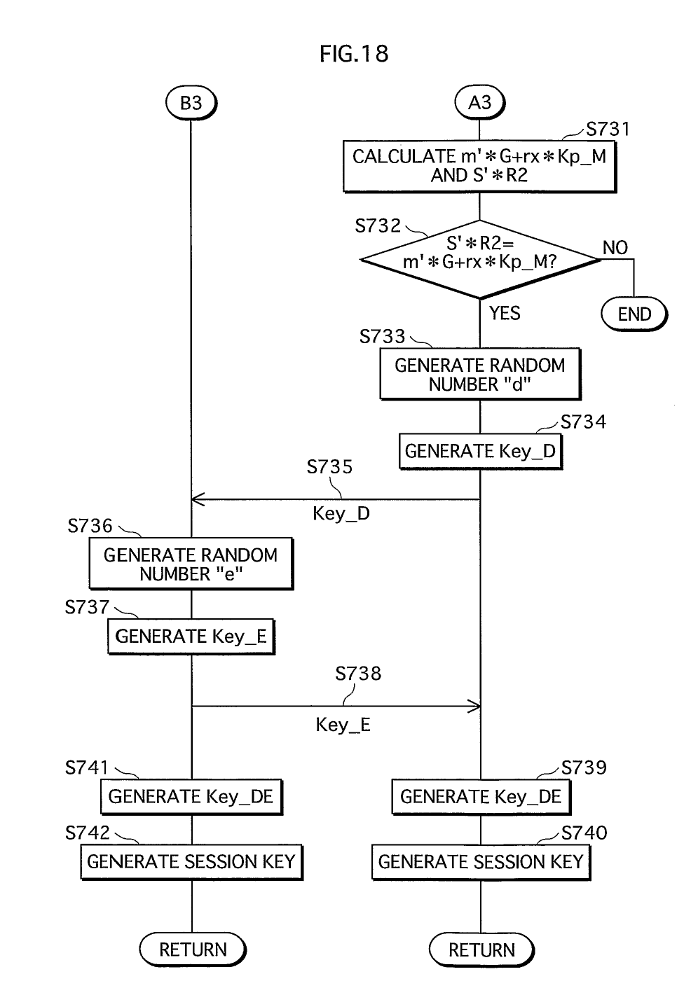

Here, the operations for establishing the SAC between the terminal device 10 and each server at the time of the service usage, with reference to the flowcharts shown in FIG. 16, FIG. 17 and FIG. 18. Note that the details of Step S606 in FIG. 15 are described here.

Here, Gen( ) is a key generation function, and Y is a parameter unique to the system. Gen (X, GEN(Y, Z))=Gen (Y, Gen (X, Z)) is satisfied.

First, the control unit 103 of the terminal device 10 reads out the public key certification Cert_0010 from the memory card 20 via the memory card input/output unit 104 (Step S701). The communication unit 101 of the terminal device 10 transmits the Cert_0010 to the server via the network 60, and the communication unit of the server receives the Cert_0010 (Step S702). The public key encryption unit of the server applies a signature verification algorithm to the signature data Sig_0010CA included in the public key certification Cert_0010 with use of a public key PK_CA of the CA (Step S703). If the verification fails (NO in Step S704), the server finishes the processing. If the verification succeeds (YES in Step S704), the control unit of the server reads out the CRL from the CRL storage unit (Step S705), and judges whether the ID_0010 included in the public key certification Cert_0010 is listed in the CRL.

If it is judged that the ID_0010 is listed in the CRL (YES in Step S706), the server finishes the processing. If it is judged that the ID_0010 is not listed in the CRL (NO in Step S706), the control unit of the server reads out the public key certification Cert_L from the Cert management unit (Step S707). The control unit transmits the public key certification Cert_L to the terminal device 10 via the communication unit and the network 60, and the communication unit of the terminal device 10 receives the Cert_L (Step S708).

Upon receiving the public key certification Cert_L, the control unit 103 of the terminal device 10 applies a signature verification algorithm to the signature data Sig_LCA included in the Cert_L with use of a public key PK_CA of the CA, in order to verify the signature (Step S709). If the verification fails (NO in Step S710), the terminal device 10 finishes the processing. If the verification succeeds (YES in Step S710), the control unit 103 reads out the CRL from the CRL storage unit 106 (Step S711), and judges whether the received ID_L that is included in the public key certification Cert_L is listed in the CRL.

If it is judged that the ID_L is listed in the CRL (YES in Step S712), the terminal device 10 finishes the processing. If it is judged that the ID_L is not listed in the CRL (NO in Step S712), the terminal device 10 continues the processing.

After the processing in Step S707, the public key encryption unit of the server generates a random number Cha_D (Step S713). The communication unit of the server transmits the random number Cha_D to the terminal device 10 via the network 60, and the communication unit 101 of the terminal device 10 receives the random number Cha_D (Step S714).

Upon receiving the random number Cha_D, the public key encryption unit 107 calculates
R1=(rx,ry)=Cha_{—}D*G (Step S715),
and calculates S by

S×Cha_D=m+rx×SK(mod q) (Step S716). Here, q is an order of the elliptic curve E, m is a message that the terminal device transmits to the server, and SK is a private key for service of the terminal device 10 read out from the secure area 204a of the memory card 20 via the memory card input/output unit 104.

The terminal device generates signature data Sig_d=(R1, S) from the obtained R1 and S(Step S717), and outputs the generated signature data Sig_d and the message m to the server, and the server receives the signature data Sig_d and the message m (Step S718).

The public key encryption unit of the server calculates
m*G+rx*PK_N,
and further calculates
S*R1 (Step S719).

The public key encryption unit of the server identifies the terminal device 10 that has transmitted the data, by judging whether S*R1=m*G+rx*PK_N is satisfied (Step S720). This equation is derivable from the following.

$$\begin{matrix}S * R 1 = \{ ( ( m + rx \times SK ) / Cha\_D ) \times Cha\_D \} * G \\ = ( m + rx \times SK ) * G \\ = m * G + ( rx \times SK ) * G \\ = m * G + rx * PK\_N .\end{matrix}$$

If S*R1≠m*G+rx*PK_N(NO in Step S720), the server finishes the processing. If S*R1=m*G+rx*PK_N (YES in Step S720), the server continues the processing.

Meanwhile, after the terminal device 10 transmits the Sig_d and the m to the server in Step S718, the public key encryption unit 107 generates a random number Cha_E (Step S721), outputs the generated random number Cha_E to the server via the control unit 103, the communication unit 101 and the network 60, and the communication unit of the server receives the Cha_E (Step S722).

Upon receiving the random number Cha_E via the control unit, the public key encryption unit of the server calculates
R2=(rx,ry)=Cha_{—}E*G (Step S723),
and also calculates S′ by
S′×cha_{—}E=m′+rx×Ks_{—}M(mod q) (Step S724).
Here, the m′ is a message that the server transmits to the terminal device 10, and the Ks_M (M=30, 40 or 50) is the private key of the server. More specifically, Ks_30 is the private key of the server 30, Ks_40 is the private key of the server 40, and Ks_50 is the private key of the server 50.

The server generates signature data Sig_e=(R2, S′) from the obtained R2 and S′ (Step S725), and outputs the generated signature data Sig_e and the message m′ to the terminal device 10, and the terminal device receives the signature data Sig_e and the message m (Step S726).

The public key encryption unit 107 of the terminal device calculates
m′*G+rx*Kp_M (Step S731).
Here, the Kp_M (M=30, 40 or 50) is the public key of each server generated by calculating Kp_M=Ks_M*G. More specifically, Kp_30 is the public key of the server 30, Kp_40 is the public key of the server 40 and Kp_50 is the public key of the server 50.

The public key encryption unit 107 further calculates
S′*R2 (Step S731).

The public key encryption unit 107 identifies the terminal device 10 that has transmitted the data, by judging whether S′*R2=m′*G+rx*Kp_M is satisfied (Step S732). This equation is derivable from the following.

$$\begin{matrix}{S}^{′} * R 2 = \{ ( ( {m}^{′} + rx \times Ks\_M ) / Cha\_E ) \times Cha\_E \} * G \\ = ( {m}^{′} + rx \times Ks\_M ) * G \\ = {m}^{′} * G + ( rx \times Ks\_M ) * G \\ = {m}^{′} * G + rx * Kp\_M .\end{matrix}$$

If S′*R2≠m*G+rx*Kp_M (NO in Step S732), the terminal device 10 finishes the processing. If S′*R2=m′*G+rx*Kp_M (YES in Step S732), the public key encryption unit 107 generates a random number “d” (Step S733), and generates Key_D=Gen(d, Y) with use of the generated random number “d” (Step S734). The communication unit 101 of the terminal device 10 transmits the Key_D generated by the public encryption unit 107 to the server via the network 60, and the communication unit of the server receives the Key_D (Step S735).

Upon receiving the Key_D, the public key encryption unit of the server generates a random number “e” (Step S736), and generates Key_E=Gen (e, Y) with use of the generated random number “e” (Step S737). The communication unit of the server outputs the Key_E generated by the public encryption unit to the terminal device 10 via the network 60, and the communication unit of the terminal device 10 receives the Key_E (Step S738). The public key encryption unit of the server generates Key_DE=Gen(e, Key_D)=Gen(e, Gen(d, Y)) with use of the random number “e” generated in Step S735 and Key_D received in Step S735 (Step S741), and outputs the generated Key_DE as the session key to the control unit (Step S742). After that, the server goes back to Step S607 in FIG. 15 and continues the processing.

Meanwhile, upon receiving the Key_E in Step S378, the public key encryption unit 107 of the terminal device 10 generates Key_DE=Gen(d, Key_E)=Gen(d, Gen(e, Y)) from the Key_E and the random number “d” that is generated in Step S733 (Step S739), and outputs the generated Key_DE as the session key to the control unit 103 (Step S740). After that, the terminal device 10 goes back to Step S610 in FIG. 15, and continues the processing.

(7) Operations for Generating System Parameters for Elliptic Curve

In the information security system 1, the Certification Authority (CA) has a function for issuing the public key certification to each device, and a function for generating system parameters that are suitable for the encryption, and transmitting the generated system parameters to each server. Here, “system parameters for the elliptic curve” represents a” and “b” included in the elliptic curve E: y²=x³+ax+b, a prime number “p”, an order of p “q”, and a base point “G” on the elliptic curve E. Especially in this system, the CA generates a unique set of the parameters for each server.

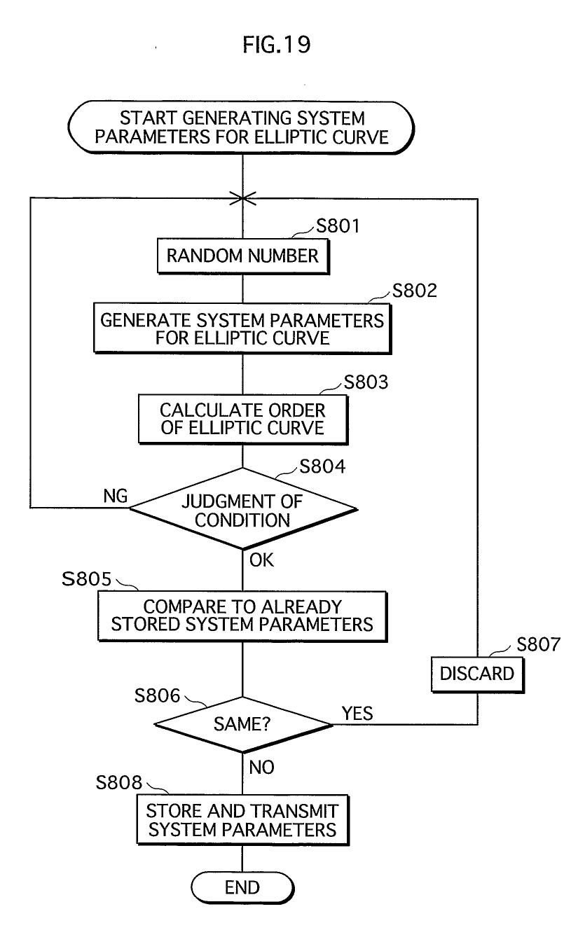

The operations performed by the CA for generating the system parameters for the elliptic curve, with reference to a flowchart shown in FIG. 19.

An elliptic curve management device included in the CA generates a random number (Step S801), generates the a, the b, the prime number q, and the base point G, which determine the elliptic curve (Step S802), and calculates the order of the elliptic curve with use of the generated parameters (Step S803).

Next, with use of the derived order, the security of the elliptic curve is judged by judging whether the following conditions for a secure elliptic curve are satisfied.

If the elliptic curve is on a finite field, the conditions for the elliptic curve to be secure against all existing cryptanalysis are:

(Condition 1) The order of the elliptic curve is not p, not p−1 and not p+1.

(Condition 2) The order of the elliptic curve has a large prime number.

According to “Encryption, Zero Knowledge Interactive Proof, and Arithmetic” (pp. 155-156, supervised by Information Processing Society of Japan, edited by Tatsuaki Ohta and Kazuo Ohta, Kyoritsu Shyuppan co., Ltd, 1995), if the conditions above are satisfied, exponential time is required for breaking the encryption regarding the largest prime number of the order.

If the condition 1 and the condition 2 are not satisfied (NG in Step S804), the processing goes back to Step S801, and repeats the generation of the random number, generation of the system parameters for the elliptic curve, the calculation of the order of the elliptic curve, and the judgment of the conditions.

If the condition 1 and the condition 2 are satisfied (OK in Step S804), the elliptic curve management device compares the newly generated system parameters to the already generated and stored system parameters (Step S805). If the newly generated set of the parameters is the same as any set of the already stored system parameters (YES in Step S806), the elliptic curve management device discards the generated system parameters (Step S807), goes back to Step S801 and continues the processing.

If the newly generated set of the parameters is not the same as any set of the already stored system parameters (NO in Step S806), the elliptic curve management device stores the newly generated sets of the system parameters, and at the same time, transmits those parameters to the servers 30, 40 or 50 (Step S808).

Note that the elliptic curve management device performs the above-described processing every time the elliptic curve management device receives the request from the servers 30, 40 or 50.

This allows each of the servers 30, 40 and 50 to acquire a unique set of the system parameters for the elliptic curve.

### SUMMARY

As described above, in the present invention, it is assumed that the public key cryptosystem used for the SAC is the elliptic curve cryptosystem, for instance. In the elliptic curve cryptosystem, the public key is calculated after the private key is generated. The private key and the system parameters are used for calculating the public key, and when the private key is the same, different public keys will be generated if the system parameters are different.

In the present invention, the server that provides the contents distribution services transmits the system parameters, which is for the service of the server itself, to the terminal device that uses the services. If there are a plurality of such servers that provide the contents distribution services, the terminal device acquires different set of the system parameters from each server.

The terminal device calculates the public key from the private key that is already stored in the terminal device and the received parameters, and transmits the calculated public key to the server. The server that receives the public key generates the public key certification by adding a signature to the public key, and returns the public key certification to the terminal device.

Modifications

The present invention is described above according to the embodiments of the present invention. However, the present invention is not limited to the above-described embodiments, as a matter of course. The following modifications are included in the present invention.

(1) In the above-described embodiments, among the system parameters for the elliptic curve, which the terminal device 10 acquires from each server, the t G is different for each server. However, the present invention is not limited to this. At least the prime number p or the base point G has to be different for each server. As a matter of course, the case where each parameter included in the set of parameters is different for each server is included in the present invention. In the present invention, the object of differentiating, for each server, the set of system parameters for the elliptic curve received by the terminal device 10 is to generate different public key for each server. The differentiation of the system parameters itself is not the object of the present invention.

(2) The above-described invention has a structure in which the terminal 10 generates the public keys PK_A, PK_B and PK_C from the private key SK and the system parameters. However, the public keys are not necessarily generated by the terminal device 10. The following cases are included in the present invention as well.

(a) The case where the server generates the public key.

Firstly, the SAC is established between the terminal device 10 and each server.

The terminal device 10 generates the private key for service SK, and transmits the generated private key for service to each server via the SAC in the safe and secure manner.

Each server generates the public key corresponding to the private key for service SK from the private key for service SK of the terminal device 10 and the system parameters for the elliptic curve acquired from the CA. Each server generates the public key certification by adding each server's own signature to the generated public key, and returns the generated public key certification to the terminal device 10.

(b) The case where the Certification Authority (CA) generates the public key.

Firstly, the SAC is established between the terminal device 10 and the CA.

The CA generates the three different sets of system parameters. The terminal device 10 generates the private key for service SK, and transmits the generated private key for service SK to the CA via the SAC in the safe and secure manner.

Upon receiving the private key SK form the terminal device 10, the CA generates three different public keys from the one private key SK and the three sets of the system parameters. The CA transmits the generated three public keys to the terminal device.

Upon receiving the three public keys, the terminal device transmits the three public keys to the servers 30, 40 and 50 respectively. Each server receives the public key from the terminal device, and generates the public key certification by adding the signature to the received public key, and returns the generated public key certification to the terminal device 10.

(3) The public key cryptosystem used for generating the signature data and verifying the signature data at the time of establishing the SAC is not limited to the elliptic curve cryptosystem. The structure that uses the RSA cryptosystem as the public key cryptosystem is included in the present invention. The following describes the embodiments that use the RSA cryptosystem.

Basic Points of RSA Cryptosystem

Public Key: N, e

Private key: P, Q, d
N=P×Q,(e,(P−1)(Q−1))=1
ed≡1 mod(P−1)(Q−1)
Encryption: C=E(M)=M^{e} mod N
Decryption: M=D(C)=C^{d} mod N
Operations

The following describe the operations performed by the terminal device 10 for receiving the public key certification from the server 30, the server 40 and the server 50.

(Step 1) The terminal device 10 selects arbitrary two large prime numbers P₁ and Q₁ which are different from each other. The terminal device 10 also generates a private key d by a random number generator, and so on.

(Step 2) The terminal device 10 calculates N₁=P₁×Q₁. The terminal device 10 also calculates e₁ from e₁d≡1 mod(P₁−1)(Q₁−1)

(Step 3) The terminal device 10 transmits the public key (N₁, e₁) to the server 30, receives the public key certification from the server 30, and stores the public key certification.

(Step 4) The terminal device 10 deletes P₁ and Q₁ and stores the private key d in a secure storage area.

(Step 5) The terminal device 10 selects two large prime numbers P₂ and Q₂ which are respectively different from P₁ and Q₁.

(Step 6) The terminal device 10 calculates N₂=P₂×Q₂. The terminal device 10 also calculates e₂ from e₂d≡1 mod(P₂−1)(Q₂−1).

(Step 7) The terminal device 10 transmits the public key (N₂, e₂) to the server 40, receives the public key certification from the server 40, and stores the public key certification.

(Step 8) The terminal device 10 deletes P₂ and Q₂.

(Step 9) The terminal device 10 selects two large prime numbers P₃ and Q₃ which are respectively different from P₁ and Q₁ and P₂ and Q₂.

(Step 10) The terminal device 10 calculates N₃=P₃×Q₃. The terminal device 10 also calculates e₃ from e₃d≡1 mod(P₃−1)(Q₃−1).

(Step 11) The terminal device 10 transmits the public key (N₃, e₃) to the server 50, receives the public key certification from the server 50, and stores the public key certification.

(Step 12) The terminal device 10 deletes P₃ and Q₃.

In this way, the terminal device 10 can generate or acquire a plurality of sets of large prime numbers (P, Q) instead of the system parameters for the elliptic curve, and generate a plurality of public keys (N, e) from the one private key d and the plurality of sets of the prime numbers (P, Q) according to the algorithm of the RSA cryptosystem. In other words, the terminal device 10 can generate a plurality of public keys from one private key, establish the SAC with each server, and transmit and receive contents with use of the generated public keys not only according to the elliptic curve cryptosystem, but also according to the RSA cryptosystem.

(4) In the above-described modification that uses the RSA cryptosystem, each server may generate the public key, instead of the terminal device 10 generates the plurality of public keys.

(5) In the embodiments, the terminal device and each server have structures in which they receive the CRL from the CA via the network 60. However, the way of acquiring the CRL is not limited to this. The CRL may be received via broadcast wave, or it may be recorded on a recording medium and distributed.

(6) The private key, the public key and the contents may be stored in a storage area in the terminal device, instead of being stored in the memory card. However, at least the private key should be stored in a secure storage area.

(7) In the above-described embodiments, the terminal device 10 has functions of generating the private key and the public key, and establishing the SAC). However, the terminal device 10 is not necessarily required to perform such processing. The present invention includes cases where a memory card having IC chip (hereinafter called “the IC memory card”) that is inserted in a terminal device connected to the network performs processing of generating the private key and the public key, and establishing the SAC, and so on.

The following describes an embodiment of the present invention where the IC memory card is used.

The IC memory card is inserted in the terminal device, and it can communicate with the server 30, the server 40, and the server 50 via the terminal device.

The IC memory card includes a storage area and a control unit that is structured by an IC chip, a ROM, a RAM and so on. Note that a part of the storage area is a secure area that is secure against tampering and cryptanalysis from outside.

Previously, the IC memory card communicates with the CA via the terminal device, receives, from the CA, the public key certification that is issued by the CA and includes the device ID of the memory card, the public key of the IC memory card, and the signatured at a generated by the CA, and stores the received public key certification in the storage area.

Further, the IC memory card stores the public key released by the server 30, the public key released by the server 40 and the public key released by the server 50 in the storage area.

(Service Subscription Request)

The following describes the processing performed by the control unit at the time when the IC memory card transmits the service subscription request to the server 30.

The control unit establishes the SAC with the server 30 with use of the RSA cryptosystem as the algorithm of the public key cryptosystem. This SAC establishment is performed in the same manner as the SAC establishment in the above-described embodiments, and the processing performed by terminal device 10 in the embodiments is here performed by the IC memory card.

Using the SAC established between the IC memory card and the server 30, the control unit receives the system parameters “a₁, b₁, p₁, q₁ and G₁” from the server 30 via the terminal device.

The control unit generates the private key for service, and calculates the public key with use of the generated private key for service and the system parameters. The control unit writes the generated private key for service into the secure area, and transmits the calculated public key to the server 30 via the terminal device, with use of the SAC established between the IC memory card and the server 30. After that, the control unit receives the public key certification from the server 30 via the terminal device, and writes the received public key certification into the storage area.

The processing performed by the control unit at the time when the IC memory card transmits the service subscription request to the server 40 is described next.

The control unit establishes the SAC with the server 40, and receives the system parameters for the elliptic curve “a₂, b₂, p₂, q₂ and G₂” from the server 40 via the terminal device, with use of the established SAC.

The control unit reads out the private key for service from the secure area, and calculates the public key with use of the read-out private key for service and the system parameters. The control unit transmits the calculated public key to the server 40 via the terminal device, with use of the SAC established between the IC memory card and the server 40. After that, the control unit receives the public key certification from the server 40 via the terminal device, and writes the received public key certification into the storage area.

The processing performed by the control unit at the time when the IC memory card transmits the service subscription request to the server 50 is described next.

The control unit establishes the SAC with the server 50, and receives the system parameters for the elliptic curve “a₃, b₃, p₃, q₃ and G₃” from the server 50 via the terminal device, with use of the established SAC.

The control unit reads out the private key for service from the secure area, and calculates the public key with use of the read-out private key for service and the system parameters. The control unit transmits the calculated public key to the server 50 via the terminal device, with use of the SAC established between the IC memory card and the server 50. After that, the control unit receives the public key certification from the server 50 via the terminal device, and writes the received public key certification into the storage area.

In this way, the IC memory card can generate three different public keys corresponding to the servers respectively, with use of the one private key for service generated at the time of transmitting the service subscription request to the server 30 and the system parameters received from the servers.

(Service Usage Request)

The following describes the processing performed by the control unit at the time when the IC memory card transmits the service usage request to the server 30.

The control unit reads out the private key for service, the public key certification (issued by the server 30) and the public key of the server 30 from the storage area, and establishes the SAC with the server 30 with use of the read-out key information. This SAC establishment is performed in the same manner as the SAC establishment in the above-described embodiments, and the processing performed by terminal device 10 in the embodiments is here performed by the IC memory card. Note that the algorithm of the public key cryptosystem used in the SAC establishment processing is the elliptic curve cryptosystem.

The control unit receives the encrypted contents from the server 30 via the terminal device with use of the SAC established between the IC memory card and the server 30, decrypts the received encrypted contents and stores the decrypted contents in the storage area.

The processing performed by the control unit at the time when the IC memory card transmits the service usage request to the server 40 is described next. The control unit reads out the private key for service, the public key certification (issued by the server 40) and the public key of the server 40 from the storage area, and establishes the SAC with the server 40 with use of the read-out key information.

The control unit receives the encrypted contents from the server 40 via the terminal device with use of the SAC established between the IC memory card and the server 40, decrypts the received encrypted contents and stores the decrypted contents in the storage area.

The processing performed by the control unit at the time when the IC memory card transmits the service usage request to the server 50 is described next. The control unit reads out the private key for service, the public key certification (issued by the server 50) and the public key of the server 50 from the storage area, and establishes the SAC with the server 50 with use of the read-out key information.

The control unit receives the encrypted contents from the server 50 via the terminal device with use of the SAC established between the IC memory card and the server 50, decrypts the received encrypted contents and stores the decrypted contents in the storage area.

In this way, the terminal device in which the IC memory card is inserted and other devices can reproduce the contents acquired from the servers 30, 40 and 50.

(8) In the above described embodiments, the CA generates a different set of the parameters for each server, and transmits the generated set of the parameters to each server. However, the servers are not necessarily required to acquire the system parameters from outside, such as the CA. The structure in which the servers themselves generate the system parameters is acceptable.

In such case where the servers themselves generate the system parameters, the terminal device generates the different public key for each server (provider). Therefore, the different ID may be allocated to each server, and the server may generate the system parameters based on the allocated ID.

(9) The present invention may be the methods described above. Also, the present invention may be a computer program that realizes the methods with a computer, and may be a digital signal that includes the computer program.

The present invention may be a computer-readable recording medium, such as a flexible disk, a hard disk, a CD-ROM, an MO, a DVD, a DVD-ROM, a BD (Blu-ray Disc), and a semiconductor memory, on which the computer program or the digital signal is recorded. Also, the present invention may be such a computer program or a digital signal, which is recorded on the recording medium.

The present invention may transmit the computer program or the digital signal via a network and so on represented by such as an electric communication line, a radio or wired communication line, and the Internet.

The present invention may be a computer system that includes a microprocessor and a memory, where the memory stores the above-described compute program, and the microprocessor operates according to the computer program.

Also, the program or the digital signal may be executed by other independent computer system, by transmitting the recording medium, on which the program or the digital signal is recorded, to the computer system, or by transmitting the program or the digital signal via the network and so on to the computer system.

(10) The present invention also includes structures that combine any of the above-described embodiments and modifications.

### INDUSTRIAL APPLICABILITY

The information security system described above is usable in industries which distribute digitalized contents such as movies and music via broadcast, a network and so on, as a system in which a user uses a plurality of service providers.

1. An information security apparatus that manages information in a safe and reliable manner based on a complexity of an inverse operation on a set of integers that satisfy a condition, the information security apparatus comprising:
a private key generating unit operable to generate a private key;
a parameter receiving unit operable to receive parameters which respectively determine conditions; and
a public key generating unit operable to generate, with use of the private key, public keys from sets of integers that satisfy the conditions determined by the parameters.

2. The information security apparatus of claim 1, wherein
the information security apparatus is connected to servers via a network,
the parameters are received from the servers respectively and are different from each other, and
the public key generating unit generates public keys which are different from each other, with use of the respective parameters.

3. The information security apparatus of claim 2, further comprising:
a public key transmission unit operable to transmit the public keys to respective source servers that are sources of the respective parameters;
a public key certification receiving unit operable to receive public key certifications from the respective servers, each public key certification including each public key and a signature of each server; and
a key storage unit operable to store the private key and the public key certifications.

4. The information security apparatus of claim 3, further comprising:
a contents request unit operable to read out one of the public key certifications from the key storage unit, and transmit a contents request that includes the read-out public key certification to a source server that has issued the read-out public key certification; and
a contents acquiring unit operable to acquire contents from the source server in a safe and reliable manner with use of the private key and the public key included in the read-out public key certification.

5. The information security apparatus of claim 4, wherein
the contents acquiring unit includes:
an authenticating unit operable to transmit, to the source server, signature data that is generated with use of the private key and to be authenticated by the source server with use of the public key, and authenticate the source server;
a key sharing unit operable to share key information with the source server if the authentication performed by the authentication unit succeeds;
a receiving unit operable to receive encrypted contents, which are encrypted based on the key information, from the source server; and
a decrypting unit operable to decrypt the encrypted contents based on the key information.

6. The information security apparatus of claim 3, wherein
the key storage unit is a portable memory card that is inserted in the information security apparatus,
the public key generating unit writes the private key and the public key certifications into the potable memory card, and
the portable memory card includes a secure storage area that is secure against tampering and cryptanalysis from outside, and stores the private key in the secure storage area.

7. The information security apparatus of claim 6, further comprising:
a memory card authenticating unit operable to authenticate the memory card when the memory card is inserted into the information security apparatus; and
a write-inhibit unit operable to inhibit the public key generating unit from writing the private key and the public key certifications into the memory card if the authentication performed by the memory card authenticating unit fails.

8. The information security apparatus of claim 1, wherein
security of the information security apparatus is based on an elliptic curve discrete logarithm problem,
the parameter receiving unit receives parameters that constitute an elliptic curve, and
the public key generating unit generates the public keys by performing, for each parameter, a multiplication with use of the elliptic curve on the private key.

9. The information security apparatus of claim 8, wherein
the private key generating unit generates a private key SK,
the parameter receiving unit receives sets of parameters, each including a and b constituting the elliptic curve y²=x³+ax+b, a prime number p, and a base point G on the elliptic curve, and
the public key generating unit generates the public keys by calculating SK*G(mod p) for each set of the parameters.

10. The information security apparatus of claim 1, wherein
security of the information security apparatus is based on an RSA cryptosystem,
the private key generating unit generates a private key d,
the parameter receiving unit receives sets of prime numbers (P, Q) as the parameters, and
the public key generating unit generates sets of the public keys (N, e) by calculating N=PQ and further calculating e from ed≡1 mod(P−1)(Q−1), for each set of the prime numbers.

11. A memory card that manages information in a safe and reliable manner based on a complexity of an inverse operation on a set of integers that satisfy a condition, the memory card comprising:
a private key generating unit operable to generate a private key;
a parameter receiving unit operable to receive parameters which respectively determine conditions;
a public key generating unit operable to generate, with use of the private key, public keys from sets of integers that satisfy the conditions determined by the parameters, and
a private key storage unit operable to store the private key in an area that is secure against tampering and cryptanalysis from outside.

12. The memory card of claim 11, wherein
the memory card is inserted in a terminal device that is connected to servers via a network,
the parameters are received from the servers respectively via the terminal device and are different from each other, and
the public key generating unit generates public keys which are different from each other, with use of the respective parameters.

13. The memory card of claim 12, wherein
the memory card acquires, in a safe and secure manner, contents from each server via the terminal device, with use of the private key and the public keys.

14. An information security system that manages information in a safe and reliable manner based on a complexity of an inverse operation on a set of integers that satisfy a condition, the information security apparatus comprising:
a private key generating unit operable to generate a private key;
a parameter receiving unit operable to receive parameters which respectively determine conditions; and
a public key generating unit operable to generate, with use of the private key, public keys from sets of integers that satisfy the conditions determined by the parameters.

15. A key generating method used for an information security apparatus that manages information in a safe and reliable manner based on a complexity of an inverse operation on a set of integers that satisfy a condition, the key generating method comprising steps of:
generating a private key;
receiving parameters which respectively determine conditions; and
generating, with use of the private key, public keys from sets of integers that satisfy the conditions determined by the parameters.

16. A key generating program used for an information security apparatus that manages information in a safe and reliable manner based on a complexity of an inverse operation on a set of integers that satisfy a condition, the key generating program comprising steps of:
generating a private key;
receiving parameters which respectively determine conditions; and
generating, with use of the private key, public keys from sets of integers that satisfy the conditions determined by the parameters.

17. A computer-readable recording medium having recorded thereon a key generating program used for an information security apparatus that manages information in a safe and reliable manner based on a complexity of an inverse operation on a set of integers that satisfy a condition, the key generating program comprising steps of:
generating a private key;
receiving parameters which respectively determine conditions; and
generating, with use of the private key, public keys from sets of integers that satisfy the conditions determined by the parameters.
